(19) United States
(12) Patent Application Publication
(10) Pub. No.: US 2005/0148487 A1
(43) Pub. Date: Jul. 7, 2005

(54) Method of decomposing polymer

(76) Inventors: Thomas Fairchild Brownscombe, Bellaire, TX (US); Scott Lee Wellington, Bellaire, TX (US)

Correspondence Address: Del S. Christensen;Shell Oil Company, Legal - Intellectual Property, P.O. Box 2463, Houston, TX, 77252-2463, US

(21) Appl. No.: 11/014,932

(22) Filed: Dec. 17, 2004

Related U.S. Application Data
(60) Provisional application No. 60/531,506, filed on Dec. 19, 2003.

(51) Int. Cl. C11D 17/00

(52) U.S. Cl. 510/446

(57) ABSTRACT

Inventions described herein generally relate a process for contacting a polymeric feed with one or more inorganic salt catalysts to produce a total product comprising a liquid product and, in some embodiments, non-condensable gas. In some embodiments, the inorganic salt catalyst exhibits an emitted gas inflection of an emitted gas in a temperature range between 50° C. and 500° C., as determined by Temporal Analysis of Products. In some embodiments, the inorganic salt catalyst has a heat transition in a temperature range between 200° C. and 500° C., as determined by differential scanning calorimetry (DSC), at a rate of 10° C. per minute. Inventions described herein also generally relate to compositions that have novel combinations of components therein.

### FIELD OF INVENTION

The present invention relates to methods for decomposing polymeric compositions to produce hydrocarbon-containing gases and liquids. The present invention further relates to methods for decomposing waste tires, waste plastics or waste thermoset resins to produce commercially useful chemicals and/or fuel oil.

### DESCRIPTION OF RELATED ART

There is a continuous increase in polymeric waste materials produced, in particular worn automotive tires, waste plastic and thermoset polymeric materials, and it has reached such a level that the depositing of such waste material increasingly presents a problem.

Attempts have been made in the art to non-catalytically decompose tires and plastics by heat, that is, by pyrolysis using, for example, hot baths of sand, rocks, gravel, heated machinery such as kilns, especially rotary kilns such as cement kilns, and other means of heating the materials to be decomposed.

U.S. Pat. No. 5,449,438 discloses a method for the pyrolysis of crushed organic waste matter, such as polyolefin waste from worn tires, in baskets immersed in a heat transfer medium such as solder, molten metal, molten salts, sand, or gravel. Examples of metal bath made of tin, lead, zinc or alloys thereof, or a molten salt bath of hydroxides, carbonates and/or other salts of alkali and/or alkaline earth metals or mixtures thereof. The operation is completely water and oxygen free and the waste material is immersed in the heat transfer medium without intimate mixing.

JP 08-209151 discloses the pyrolysis of polyvinylchloride (PVC) wherein basic materials such as KOH and NaOH are added to neutralize the corrosive hydrogen chloride generated during the pyrolysis of the chlorine-containing polyvinylchloride. The basic materials are consumed during the process and do not maintain its super basic property, thus do not serve a catalytic function for the general decomposition, but merely as sinks for a particular acidic by-product.

In such pyrolysis processes, gases and solids are produced in significant amounts, although liquid materials generally have the greatest value. Moreover, the products, including the liquid products, often are of a low grade or economically of low value. There is a significant economic and technical need for an improved process for conversion of polymeric wastes into greater yield of desired products according to market needs over that obtained by pyrolysis. There is also a desire to increase rates of reaction, and catalytic transformation of the products such as the in-situ generation of hydrogen and isomerization of intermediate products to produce more valuable products.

### SUMMARY OF THE INVENTION

Inventions described herein generally relate a process for contacting a polymeric feed with one or more inorganic salt catalysts to produce a total product comprising a liquid product and, in some embodiments, non-condensable gas. In some embodiments, the inorganic salt catalyst exhibits an emitted gas inflection of an emitted gas in a temperature range between 50° C. and 500° C., as determined by Temporal Analysis of Products. In some embodiments the inorganic salt catalyst has a heat transition in a temperature range between 200° C. and 500° C., as determined by differential scanning calorimetry (DSC), at a rate of 10° C. per minute. Inventions described herein also generally relate to compositions that have novel combinations of components therein.

In some embodiments, the polymeric feed may be polyolefins, polyethyleneterephthalate (PET), polyethylene, polypropylene, epoxy resins, methyl methacrylate, polyurethanes, furan resins, rubber, and polymeric wastes, such as waste tires, paper, and municipal plastic wastes.

In further embodiments, features from specific embodiments of the invention may be combined with features from other embodiments of the invention. For example, features from one embodiment may be combined with features from any of the other embodiments.

In further embodiments, products are obtainable by any of the methods and systems described herein.

In further embodiments, additional features may be added to the specific embodiments described herein.

### BRIEF DESCRIPTION OF THE DRAWINGS

Advantages of the present invention will become apparent to those skilled in the art with the benefit of the following detailed description and upon reference to the accompanying drawings in which:

FIG. 1 is a schematic of an embodiment of a contacting system for contacting the polymeric feed with a hydrogen source in the presence of one or more catalysts to produce the total product.

FIG. 2 is a schematic of another embodiment of a contacting system for contacting the polymeric feed with a hydrogen source in the presence of one or more catalysts to produce the total product.

FIG. 3 is a schematic of a system that may be used to measure ionic conductivity.

FIG. 4 is a plot of the difference between the weight of product distilled for a product produced in the presence of the inorganic salt catalyst vs a product produced without the presence of the inorganic salt catalyst as a function of temperature for tire material as feed.

FIG. 5 is a plot of the difference in temperature between the distillation curves of FIG. 4 a function of the percent by weight of product distilled.

FIG. 6 is a plot of the difference between the weight of product distilled for a product produced in the presence of the inorganic salt catalyst vs a product produced without the presence of the inorganic salt catalyst as a function of temperature for high density polyethylene as feed.

FIG. 7 is a plot of the difference in temperature between the distillation curves of FIG. 6 a function of the percent by weight of product distilled.

FIG. 8 is plot of the ratio of alpha olefins to paraffins between product produced in the presence of the inorganic salt catalyst vs. a product produced without the presence of the inorganic salt catalyst, as a function of carbon number.

FIG. 9 is a graphical representation of log 10 plots of ion currents of emitted gases of an inorganic salt catalyst versus temperature, as determined by TAP.

FIG. 10 is a graphic representation of log plots of the resistance of inorganic salt catalysts and an inorganic salt relative to the resistance of potassium carbonate versus temperature.

FIG. 11 is a graphic representation of log plots of the resistance of a Na₂CO₃/K₂CO₃/Rb₂CO₃ catalyst relative to resistance of the potassium carbonate versus temperature.

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but on the contrary, the intention is to cover all modifications, equivalents, and alternatives falling within the spirit and scope of the present invention.

### DETAILED DESCRIPTION OF THE INVENTIONS

Certain embodiments of the inventions are described herein in more detail.

Examples of polymeric materials that can be treated using the processes described herein include, but are not limited to, polyolefins, polyethyleneterephthalate (PET), polyethylene, polypropylene, epoxy resins, methyl methacrylate, polyurethanes, furan resins, rubber, and the like. Polymeric wastes, such as waste tires, paper, and municipal plastic wastes are particularly of interest for converting polymeric wastes to commercially useful chemicals and fuels. In general, natural or synthetic polymers, including normally included addititives, fillers, extenders and modifiers may be subjected to the present process. In some embodiments, non-halogen containing polymers are utilized as the polymeric materials that can be treated according to the present invention to reduce catalyst spent neutralizing acidic byproducts.

Terms used herein are defined as follows.

“Alkali metal(s)” refer to one or more metals from Column 1 of the Periodic Table, one or more compounds of one or more metals from Column 1 of the Periodic Table, or mixtures thereof.

“Alkaline-earth metal(s)” refer to one or more metals from Column 2 of the Periodic Table, one or more compounds of one or more metals from Column 2 of the Periodic Table, or mixtures thereof.

“AMU” refers to atomic mass unit.

“ASTM” refers to American Standard Testing and Materials.

Atomic hydrogen percentage and atomic carbon percentage of polymeric feed, liquid product, naphtha, kerosene, diesel, and VGO are as determined by ASTM Method D5291.

“API gravity” refers to API gravity at 15.5° C. API gravity is as determined by ASTM Method D6822.

Boiling range distributions for the polymeric feed and/or total product are as determined by ASTM Methods D5307, unless otherwise mentioned. Content of hydrocarbon components, for example, paraffins, iso-paraffins, olefins, naphthenes and aromatics in naphtha are as determined by ASTM Method D6730. Content of aromatics in diesel and VGO is as determined by IP Method 368/90. Content of aromatics in kerosene is as determined by ASTM Method D5186.

“Brønsted-Lowry acid” refers to a molecular entity with the ability to donate a proton to another molecular entity.

“Brønsted-Lowry base” refers to a molecular entity that is capable of accepting protons from another molecular entity. Examples of Brønsted-Lowry bases include hydroxide (OH⁻), water (H₂O), carboxylate (RCO₂⁻), halide (Br⁻, Cl⁻, F⁻, I⁻), bisulfate (HSO₄⁻), and sulfate (SO₄²⁻).

“Carbon number” refers to the total number of carbon atoms in a molecule.

“Coke” refers to solids containing carbonaceous solids that are not vaporized under process conditions of the present invention. The content of coke in a sample may be determined by mass balance with the weight of coke calculated as the total weight of solid remaining after the process of the present invention, minus the total weight of input catalysts.

“Content” refers to the weight of a component in a substrate (for example, a polymeric feed, a total product, or a liquid product) expressed as weight fraction or weight percentage based on the total weight of the substrate. “Wtppm” refers to parts per million by weight.

“Diesel” refers to hydrocarbons with a boiling range distribution between 260° C. and 343° C. (500-650° F.) at 0.101 MPa. Diesel content is as determined by ASTM Method D2887.

“Distillate” refers to hydrocarbons with a boiling range distribution between 204° C. and 343° C. (400-650° F.) at 0.101 MPa. Distillate content is as determined by ASTM Method D2887. Distillate may include kerosene and diesel.

“DSC” refers to differential scanning calorimetry.

“Freeze point” and “freezing point” refer to the temperature at which formation of crystalline particles occurs in a liquid. A freezing point is as determined by ASTM D2386.

“GC/MS” refers to gas chromatography in combination with mass spectrometry.

“Hard base” refers to anions as described by Pearson in Journal of American Chemical Society, 1963, 85, p. 3533.

“H/C” refers to a weight ratio of atomic hydrogen to atomic carbon. H/C is as determined from the values measured for weight percentage of hydrogen and weight percentage of carbon by ASTM Method D5291.

“Heteroatoms” refer to oxygen, nitrogen, and/or sulfur contained in the molecular structure of a hydrocarbon. Heteroatoms content is as determined by ASTM Methods E385 for oxygen, D5762 for nitrogen, and D4294 for sulfur.

“Hydrogen source” refers to hydrogen, and/or a compound and/or compounds when in the presence of a polymeric feed and the catalyst react to provide hydrogen to one or more compounds in the polymeric feed. A hydrogen source may include, but is not limited to, hydrocarbons (for example, C₁ to C₆ hydrocarbons such as methane, ethane, propane, butane, pentane, naphtha), water, or mixtures thereof. A mass balance is conducted to assess the net amount of hydrogen provided to one or more compounds in the polymeric feed.

“Inorganic salt” refers to a compound that is composed of a metal cation and an anion.

“IP” refers to the Institute of Petroleum, now the Energy Institute of London, United Kingdom.

“Iso-paraffins” refer to branched-chain saturated hydrocarbons.

“Kerosene” refers to hydrocarbons with a boiling range distribution between 204° C. and 260° C. (400-500° F.) at 0.101 MPa. Kerosene content is as determined by ASTM Method D2887.

“Lewis acid” refers to a compound or a material with the ability to accept one or more electrons from another compound.

“Lewis base” refers to a compound and/or material with the ability to donate one or more electrons to another compound.

“Light Hydrocarbons” refer to hydrocarbons having carbon numbers in a range from 1 to 6.

“Liquid mixture” refers to a composition that includes one or more compounds that are liquid at standard temperature and pressure (25° C., 0.101 MPa, hereinafter referred to as “STP”), or a composition that includes a combination of one or more compounds that are liquid at STP with one or more compounds that are solid at STP.

“Micro-Carbon Residue” (“MCR”) refers to a quantity of carbon residue remaining after evaporation and pyrolysis of a substance. MCR content is as determined by ASTM Method D4530.

“Naphtha” refers to hydrocarbon components with a boiling range distribution between 38° C. and 204° C. (100-400° F.) at 0.101 MPa. Naphtha content is as determined by ASTM Method D2887.

“Nm³/m³” refers to normal cubic meters of gas per cubic meter of polymeric feed.

“Nonacidic” refers to Lewis base and/or Brønsted-Lowry base properties.

“Non-condensable gas” refers to components and/or a mixture of components that are gases at standard temperature and pressure (25° C., 0.101 MPa, hereinafter referred to as “STP”).

“n-Paraffins” refer to normal (straight chain) saturated hydrocarbons.

“Octane number” refers to a calculated numerical representation of the antiknock properties of a motor fuel compared to a standard reference fuel. A calculated octane number is as determined by ASTM Method D6730.

“Olefins” refer to compounds with non-aromatic carbon-carbon double bonds. Types of olefins include, but are not limited to, cis, trans, terminal, internal, branched, and linear.

“Periodic Table” refers to the Periodic Table as specified by the International Union of Pure and Applied Chemistry (IUPAC), November 2003.

“Polyaromatic compounds” refer to compounds that include two or more aromatic rings. Examples of polyaromatic compounds include, but are not limited to, indene, naphthalene, anthracene, phenanthrene, benzothiophene, and dibenzothiophene.

“Residue” refers to components that have a boiling range distribution above 538° C. (1000° F.) at 0.101 MPa, as determined by ASTM Method D5307.

“Semiliquid” refers to a phase of a substance that has properties of a liquid phase and a solid phase of the substance. Examples of semiliquid inorganic salt catalysts include a slurry and/or a phase that has a consistency of, for example, taffy, dough, or toothpaste.

“SCFB” refers to standard cubic feet of gas per barrel of polymeric feed with standard conditions being 60° F. and one atmosphere pressure.

“Superbase” refers to a material that can deprotonate hydrocarbons such as paraffins and olefins under reaction conditions.

“TAP” refers to temporal-analysis-of-products.

“VGO” refers to components with a boiling range distribution between 343° C. and 538° C. (650-1000° F.) at 0.101 MPa. VGO content is as determined by ASTM Method D2887.

In the context of this application, it is to be understood that if the value obtained for a property of the composition tested is outside of the limits of the test method, the test method may be recalibrated to test for such property. It should be understood that other standardized testing methods that are considered equivalent to the referenced testing methods may be used.

The polymeric feed may be contacted with a hydrogen source in the presence of one or more of the catalysts in a contacting zone and/or in combinations of two or more contacting zones.

In some embodiments, the hydrogen source is generated in situ. In situ generation of the hydrogen source may include the reaction of at least a portion of the polymeric feed with the inorganic salt catalyst at temperatures in a range from 200-500° C. or 300-400° C. to form hydrogen and/or light hydrocarbons. In situ generation of hydrogen may include the reaction of at least a portion of the inorganic salt catalyst that includes, for example, alkali metal formate.

The total product generally includes gas, vapor, liquids, or mixtures thereof produced during the contacting. The total product includes the liquid product that is a liquid mixture at STP and, in some embodiments, hydrocarbons that are not condensable at STP. In some embodiments, the total product and/or the liquid product may include solids (such as inorganic solids and/or coke). In certain embodiments, the solids may be entrained in the liquid and/or vapor produced during contacting.

A contacting zone typically includes a reactor, a portion of a reactor, multiple portions of a reactor, or multiple reactors. Examples of reactors that may be used to contact a polymeric feed with a hydrogen source in the presence of catalyst include a stacked bed reactor, a fixed bed reactor, a continuously stirred tank reactor (CSTR), a spray reactor, a plug-flow reactor, and a liquid/liquid contactor. Examples of a CSTR include a fluidized bed reactor and an ebullating bed reactor. As a particular embodiment of the invention, the polymeric feed is mixed more particularly intimately mixed, with the catalyst during the decomposition reaction. This may be accomplished by chopping the polymeric waste to particles of, for example, less than about one inch in maximum width, and mixing the chopped particles with either moltent catalyst according to the present invention. Alternatively, the chopped particles could be mixed with solid catalyst, and the mixture heated to a reaction temperature.

Contacting conditions typically include temperature, pressure, polymeric feed flow, total product flow, residence time, hydrogen source flow, or combinations thereof. Contacting conditions may be controlled to produce a liquid product with specified properties.

Contacting temperatures may range from 200-800° C., 300-700° C., or 400-600° C. In embodiments in which the hydrogen source is supplied as a gas (for example, hydrogen gas, methane, or ethane), a ratio of the gas to the polymeric feed will generally range from 1-16,100 Nm³/m³, 2-8000 Nm³/m³, 3-4000 Nm³/m³, or 5-300 Nm³/m³. Contacting typically takes place in a pressure range between 0.1-20 MPa, 1-16 MPa, 2-10 MPa, or 4-8 MPa. In some embodiments in which steam is added, a ratio of steam to polymeric feed is in a range from 0.01-3 kilograms, 0.03-2.5 kilograms, or 0.1-1 kilogram of steam, per kilogram of polymeric feed. A flow rate of polymeric feed may be sufficient to maintain the volume of polymeric feed in the contacting zone of at least 10%, at least 50%, or at least 90% of the total volume of the contacting zone. Typically, the volume of polymeric feed in the contacting zone is 40%, 60%, or 80% of the total volume of the contacting zone. In some embodiments, contacting may be done in the presence of an additional gas, for example, argon, nitrogen, methane, ethane, propanes, butanes, propenes, butenes, or combinations thereof.

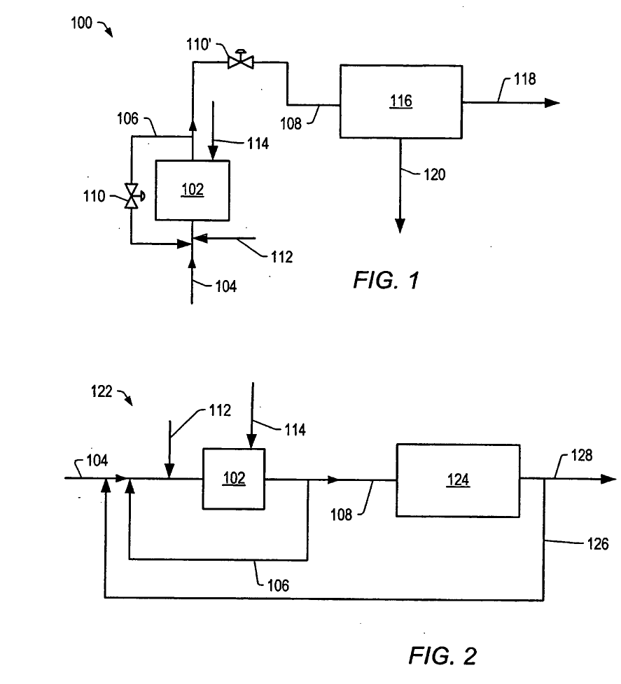

FIG. 1 is a schematic of an embodiment of contacting system 100 used to produce the total product as a vapor. The polymeric feed exits polymeric feed supply and enters contacting zone 102 via conduit 104. A quantity of the catalyst used in the contacting zone may range from 1-100 grams, 2-80 grams, 3-70 grams, or 4-60 grams, per 100 grams of polymeric feed in the contacting zone. In certain embodiments, a diluent may be added to the polymeric feed to lower the viscosity of the polymeric feed. In some embodiments, the polymeric feed enters a bottom portion of contacting zone 102 via conduit 104. In certain embodiments, the polymeric feed may be heated to a temperature of at least 100° C. or at least 300° C. prior to and/or during introduction of the polymeric feed to contacting zone 102. Typically, the polymeric feed may be heated to a temperature in a range from 100-500° C. or 200-400° C.

In some embodiments, the catalyst is combined with the polymeric feed and transferred to contacting zone 102. The polymeric feed/catalyst mixture may be heated to a temperature of at least 100° C. or alternatively at least 300° C. prior to introduction into contacting zone 102. Typically, the polymeric feed may be heated to a temperature in a range from 200-500° C. or 300-400° C. In some embodiments, the polymeric feed/catalyst mixture is a slurry. In some embodiments, the polymeric feed is added continuously to contacting zone 102. Mixing in contacting zone 102 may be sufficient to inhibit separation of the catalyst from the polymeric feed/catalyst mixture. In certain embodiments, at least a portion of the catalyst may be removed from contacting zone 102, and in some embodiments, such catalyst is regenerated and re-used. In certain embodiments, fresh catalyst may be added to contacting zone 102 during the reaction process.

Recycle conduit 106 may couple conduit 108 and conduit 104. In some embodiments, recycle conduit 106 may directly enter and/or exit contacting zone 102. Recycle conduit 106 may include flow control valve 110. Flow control valve 110 may allow at least a portion of the material from conduit 108 to be recycled to conduit 104 and/or contacting zone 102. In some embodiments, a condensing unit may be positioned in conduit 108 to allow at least a portion of the material to be condensed and recycled to contacting zone 102. In certain embodiments, recycle conduit 106 may be a gas recycle line. Flow control valves 110 and 110′ may be used to control flow to and from contacting zone 102 such that a constant volume of liquid in the contacting zone is maintained. In some embodiments, a substantially selected volume range of liquid can be maintained in the contacting zone 102. A volume of feed in contacting zone 102 may be monitored using standard instrumentation. Gas inlet port 112 may be used to allow addition of the hydrogen source and/or additional gases to the polymeric feed as the polymeric feed enters contacting zone 102. In some embodiments, steam inlet port 114 may be used to allow addition of steam to contacting zone 102. In certain embodiments, an aqueous stream is introduced into contacting zone 102 through steam inlet port 114.

In some embodiments, at least a portion of the total product is produced as vapor from contacting zone 102. In certain embodiments, the total product is produced as vapor and/or a vapor containing small amounts of liquids and solids from the top of contacting zone 102. The vapor is transported to separation zone 116 via conduit 108. The ratio of a hydrogen source to polymeric feed in contacting zone 102 and/or the pressure in the contacting zone may be changed to control the vapor and/or liquid phase produced from the top of contacting zone 102. In some embodiments, the vapor produced from the top of contacting zone 102 includes at least 0.5 grams, at least 0.8 grams, at least 0.9 grams, or at least 0.97 grams of liquid product per gram of polymeric feed. In certain embodiments, the vapor produced from the top of contacting zone 102 includes from 0.8-0.99 grams, or 0.9-0.98 grams of liquid product per gram of polymeric feed.

Used catalyst and/or solids may remain in contacting zone 102 as by-products of the contacting process. The solids and/or used catalyst may include residual polymeric feed and/or coke.

In separation unit 116, the vapor is cooled and separated to form the liquid product and gases using standard separation techniques. The liquid product exits separation unit 116 and enters liquid product receiver via conduit 118. The resulting liquid product may be suitable for transportation and/or treatment. Liquid product receiver may include one or more pipelines, one or more storage units, one or more transportation vessels, or combinations thereof. In some embodiments, the separated gas (for example, hydrogen, carbon monoxide, carbon dioxide, hydrogen sulfide, or methane) is transported to other processing units (for example, for use in a fuel cell or a sulfur recovery plant) and/or recycled to contacting zone 102 via conduit 120. In certain embodiments, entrained solids and/or liquids in the liquid product may be removed using standard physical separation methods (for example, filtration, centrifugation, or membrane separation).

FIG. 2 depicts contacting system 122 for treating polymeric feed with one or more catalysts to produce a total product that may be a liquid, or a liquid mixed with gas or solids. The polymeric feed may enter contacting zone 102 via conduit 104. In some embodiments, the polymeric feed is received from the polymeric feed supply. Conduit 104 may include gas inlet port 112. In some embodiments, gas inlet port 112 may directly enter contacting zone 102. In certain embodiments, steam inlet port 114 may be used to allow addition of the steam to contacting zone 102. The polymeric feed may be contacted with the catalyst in contacting zone 102 to produce a total product. In some embodiments, conduit 106 allows at least a portion of the total product to be recycled to contacting zone 102. A mixture that includes the total product and/or solids and/or unreacted polymeric feed exits contacting zone 102 and enters separation zone 124 via conduit 108. In some embodiments, a condensing unit may be positioned (for example, in conduit 106) to allow at least a portion of the mixture in the conduit to be condensed and recycled to contacting zone 102 for further processing. In certain embodiments, recycle conduit 106 may be a gas recycle line. In some embodiments, conduit 108 may include a filter for removing particles from the total product.

In separation zone 124, at least a portion of the liquid product may be separated from the total product and/or catalyst. In embodiments in which the total product includes solids, the solids may be separated from the total product using standard solid separation techniques (for example, centrifugation, filtration, decantation, membrane separation). Solids include, for example, a combination of catalyst, used catalyst, and/or coke. In some embodiments, a portion of the gases is separated from the total product. In some embodiments, at least a portion of the total product and/or solids may be recycled to conduit 104 and/or, in some embodiments, to contacting zone 102 via conduit 126. The recycled portion may, for example, be combined with the polymeric feed and enter contacting zone 102 for further processing. The liquid product may exit separation zone 124 via conduit 128. In certain embodiments, the liquid product may be transported to the liquid product receiver.

In some embodiments, the total product and/or liquid product may include at least a portion of the catalyst. Gases entrained in the total product and/or liquid product may be separated using standard gas/liquid separation techniques, for example, sparging, membrane separation, and pressure reduction. In some embodiments, the separated gas is transported to other processing units (for example, for use in a fuel cell, a sulfur recovery plant, other processing units, or combinations thereof) and/or recycled to the contacting zone.

The polymeric feed enters contacting system 100 via conduit 104 and is contacted with a hydrogen source in the presence of the inorganic salt catalyst to produce the total product. The total product includes hydrogen and, in some embodiments, a liquid product. The total product may exit contacting system 100 via conduit 108. The hydrogen generated from contact of the inorganic salt catalyst with the polymeric feed may be used as a hydrogen source for contacting system 148. At least a portion of the generated hydrogen is transferred to contacting system 148 from contacting system 100 via conduit 150.

In an alternate embodiment, such generated hydrogen may be separated and/or treated, and then transferred to contacting system 148 via conduit 150. In certain embodiments, contacting system 148 may be a part of contacting system 100 such that the generated hydrogen flows directly from contacting system 100 to contacting system 148. In some embodiments, a vapor stream produced from contacting system 100 is directly mixed with the polymeric feed entering contacting system 148.

In some embodiments, the liquid product and/or the blended product are transported to a refinery and/or a treatment facility. The liquid product and/or the blended product may be processed to produce commercial products such as transportation fuel, heating fuel, lubricants, or chemicals. Processing may include distilling and/or fractionally distilling the liquid product and/or blended product to produce one or more distillate fractions. In some embodiments, the liquid product, the blended product, and/or the one or more distillate fractions may be hydrotreated.

The total product includes, in some embodiments, at most 0.05 grams, at most 0.03 grams, or at most 0.01 grams of coke per gram of total product. In certain embodiments, the total product is substantially free of coke (that is, coke is not detectable). In some embodiments, the liquid product may include at most 0.05 grams, at most 0.03 grams, at most 0.01 grams, at most 0.005 grams, or at most 0.003 grams of coke per gram of liquid product. In certain embodiments, the liquid product has a coke content in a range from above 0 to 0.05, 0.00001-0.03 grams, 0.0001-0.01 grams, or 0.001-0.005 grams per gram of liquid product, or is not detectable.

In certain embodiments, the liquid product has an MCR content that is at most 90%, at most 80%, at most 50%, at most 30%, or at most 10% of the MCR content of the polymeric feed. In some embodiments, the liquid product has a negligible MCR content. In some embodiments, the liquid product has, per gram of liquid product, at most 0.05 grams, at most 0.03 grams, at most 0.01 grams, or at most 0.001 grams of MCR. Typically, the liquid product has from 0 grams to 0.04 grams, 0.000001 to 0.03 grams, or 0.00001 to 0.01 grams of MCR per gram of liquid product.

In some embodiments, the total product includes non-condensable gas. The non-condensable gas typically includes, but is not limited to, carbon dioxide, hydrogen, carbon monoxide, methane, ethylene, ethane, acetylene, n-propane, propylene, n-butane, iso-butene, t-2-butene, 1-butene, c-2-butene, iso-pentane, pentane, 1,3 butadiene, 1-pentene, cis-2-pentene, 2-methyl-2-butene, propadiene, hexane, benzene, other hydrocarbons that are not fully condensed from a hydrocarbon mixture at STP.

In certain embodiments, hydrogen gas, carbon dioxide, carbon monoxide, or combinations thereof can be formed in situ by contact of steam and light hydrocarbons with the inorganic salt catalyst. Typically, under thermodynamic conditions a molar ratio of carbon monoxide to carbon dioxide is 0.07. A molar ratio of the generated carbon monoxide to the generated carbon dioxide, in some embodiments, is at least 0.3, at least 0.5, or at least 0.7. In some embodiments, a molar ratio of the generated carbon monoxide to the generated carbon dioxide is in a range from 0.3-1.0, 0.4-0.9, or 0.5-0.8. The ability to generate carbon monoxide preferentially to carbon dioxide in situ may be beneficial to other processes located in a proximate area or upstream of the process. For example, the generated carbon monoxide may be used as a reducing agent in treating hydrocarbon formations or used in other processes, for example, syngas processes.

In some embodiments, the total product as produced herein may include a mixture of compounds that have a boiling range distribution between −10° C. and 538° C. In some embodiments, iso-paraffins are produced relative to n-paraffins at a weight ratio of at most 1.5, at most 1.4, at most 1.0, at most 0.8, at most 0.3, or at most 0.1. In certain embodiments, iso-paraffins are produce relative to n-paraffins at a weight ratio in a range from 0.00001 to 1.5, 0.0001 to 1.0, or 0.001 to 0.1. In some embodiments, the total product and/or liquid product may include olefins and/or paraffins in ratios or amounts that are not generally found in commercially or naturally available feedstocks or mixtures such as crudes produced and/or retorted from a formation or refinery or petrochemical plants. The olefins include a mixture of olefins with a terminal double bond (“alpha olefins”) and olefins with internal double bonds.

In certain embodiments, the hydrocarbons with a boiling range distribution between 20 and 400° C. have an olefins content in a range from 0.00001 to 0.1 grams, 0.0001 to 0.05 grams, or 0.01 to 0.04 grams per gram of hydrocarbons having a boiling range distribution in a range between 20 and 400° C.

In some embodiments, at least 0.001 grams, at least 0.005 grams, or at least 0.01 grams of alpha olefins per gram of liquid product may be produced. In certain embodiments, the liquid product has from 0.0001 to 0.5 grams, 0.001 to 0.2 grams, or 0.01 to 0.1 grams of alpha olefins per gram of liquid product. In certain embodiments, the hydrocarbons with a boiling range distribution between 20 to 400° C. have an alpha olefins content in a range from 0.0001 to 0.08 grams, 0.001 to 0.05 grams, or 0.01 to 0.04 grams per gram of hydrocarbons with a boiling range distribution between 20 and 400° C.

In some embodiments, the hydrocarbons with a boiling range distribution between 20 and 204° C. have a weight ratio of alpha olefins to internal double bond olefins of at least 0.7, at least 0.8, at least 0.9, at least 1.0, at least 1.4, or at least 1.5. In some embodiments, the hydrocarbons with a boiling range distribution between 20 and 204° C. have a weight ratio of alpha olefins to internal double bond olefins in a range from 0.7 to 10, 0.8 to 5, 0.9 to 3, or 1 to 2. A weight ratio of alpha olefins to internal double bond olefins of the crude oil, natural gas condensate and commercial products is typically at most 0.5. The ability to produce an increased amount of alpha olefins to olefins with internal double bonds may facilitate the conversion of the liquid product to commercial products such as detergents and surfactants.

The liquid product includes components with a range of boiling points. In some embodiments, the liquid product includes: at least 0.001 grams, or from 0.001 to 0.5 grams of hydrocarbons with a boiling range distribution of at most 200° C. or at most 204° C. at 0.101 MPa; at least 0.001 grams, or from 0.001 to 0.5 grams of hydrocarbons with a boiling range distribution between 200° C. and 300° C. at 0.101 MPa; at least 0.001 grams, or from 0.001 to 0.5 grams of hydrocarbons with a boiling range distribution between 300° C. and 400° C. at 0.101 MPa; and at least 0.001 grams, or from 0.001 to 0.5 grams of hydrocarbons with a boiling range distribution between 400° C. and 538° C. at 0.101 MPa.

In certain embodiments, naphtha may include aromatic compounds. Aromatic compounds may include monocyclic ring compounds and/or polycyclic ring compounds. The monocyclic ring compounds may include, but are not limited to, benzene, toluene, ortho-xylene, meta-xylene, para-xylene, ethyl benzene, 1-ethyl-3-methyl benzene; 1-ethyl-2-methyl benzene; 1,2,3-trimethyl benzene; 1,3,5-trimethyl benzene; 1-methyl-3-propyl benzene; 1-methyl-2-propyl benzene; 2-ethyl-1,4-dimethyl benzene; 2-ethyl-2,4-dimethyl benzene; 1,2,3,4-tetra-methyl benzene; ethyl, pentylmethyl benzene; 1,3 diethyl-2,4,5,6-tetramethyl benzene; tri-isopropyl-ortho-xylene; substituted congeners of benzene, toluene, ortho-xylene, meta-xylene, para-xylene, or mixtures thereof. Monocyclic aromatics are used in a variety of commercial products and/or sold as individual components. The liquid product produced as described herein typically has a relatively high content of monocyclic aromatics.

An increase in the aromatics content of naphtha tends to increase the octane number of the naphtha. Hydrocarbon mixtures may be valued in part based on an estimation of a gasoline potential of the naphtha. Gasoline potential may include, but is not limited to, a calculated octane number for the naphtha portion of the mixture. Crude oils typically have calculated octane numbers in a range of 35-60. A higher octane number of a naphtha tends to reduce the requirement for additives that increase the octane number of the gasoline, or for further processing to increase the octane number or for use of higher octane blending components. In certain embodiments, the liquid product includes naphtha that has an octane number of at least 60, at least 70, at least 80, or at least 90. Typically, the octane number of the naphtha is in a range from 60 to 99, 70 to 98, or 80 to 95.

In some embodiments, the kerosene and naphtha may have a total polyaromatic compounds content in a range from 0.00001 to 0.5 grams, 0.0001 to 0.2 grams, or 0.001 to 0.1 grams per gram of total kerosene and naphtha.

The liquid product may have, per gram of liquid product, a distillate content in a range from 0.0001 to 0.9 grams, from 0.001 to 0.5 grams, from 0.005 to 0.3 grams, or from 0.01 to 0.2 grams. In some embodiments, a weight ratio of kerosene to diesel in the distillate, is in a range from 1:4 to 4:1, 1:3 to 3:1, or 2:5 to 5:2.

In some embodiments, the liquid product has, per gram of liquid product, at least 0.001 grams, from above 0 to 0.7 grams, 0.001 to 0.5 grams, or 0.01 to 0.1 grams of kerosene. In certain embodiments, the liquid product has from 0.001 to 0.5 grams or 0.01 to 0.3 grams of kerosene. In some embodiments, the kerosene has, per gram of kerosene, an aromatics content of at least 0.2 grams, at least 0.3 grams, or at least 0.4 grams. In certain embodiments, the kerosene has, per gram of kerosene, an aromatics content in a range from 0.1 to 0.5 grams, or from 0.2 to 0.4 grams.

In certain embodiments, the liquid product has, per gram of liquid product, a diesel content in a range from 0.001 to 0.8 grams or from 0.01 to 0.4 grams. In certain embodiments, the diesel has, per gram of diesel, an aromatics content of at least 0.1 grams, at least 0.3 grams, or at least 0.5 grams. In some embodiments, the diesel has, per gram of diesel, an aromatics content in a range from 0.1 to 1 grams, 0.3 to 0.8 grams, or 0.2 to 0.5 grams.

In some embodiments, the liquid product has, per gram of liquid product, a VGO content in a range from 0.0001 to 0.99 grams, from 0.001 to 0.8 grams, or from 0.1 to 0.3 grams. In certain embodiments, the VGO content in the liquid product is in a range from 0.4 to 0.9 grams, or 0.6 to 0.8 grams per gram of liquid product. In certain embodiments, the VGO has, per gram of VGO, an aromatics content in a range from 0.1 to 0.99 grams, 0.3 to 0.8 grams, or 0.5 to 0.6 grams.

In some embodiments, and in particular, in some embodiments where the polymeric feed comprises tires, the noncondensible liquid product can comprise a composition with an initial boiling point of 180° F. or greater with a final boiling point less than about 1200° F. with a 50% boiling point in the range of 590° F. to 700° F. An API gravity for such a composition may be between about 15 and 40. The composition, in some such embodiments may have a ratio of olefinic bonds to aromatic bonds in the range of 0.05 to 0.35; be between about 20% and 50% aromatics by weight; contain between 0.05 and 0.5% of each of styrene, ethyl benzene, propyl benzene, and butyl benzene; with a ratio of ethyl benzene to styrene of less than one, a ratio of propyl benzene to butyl benzene of greater than one; a ratio of propyl benzene to ethyl benzene of grater than one, more than 0.00001% by weight of octadecanenitrile, and contain between 0.5 to 5% by weight limonene. Such a composition is useful as a refinery feed for producing fuels and/or chemicals, including fine chemicals by extraction of limonene. It is valuable for the production of gasoline in normal refining processes. It has a comparatively low olefin content which makes it relatively stable and transportable. It has a comparatively low sulfur content and a high paraffin content which makes it suitable feed for olefin cracking optionally after removal by fractionation of the hydrocarbons having less than about eight carbon atoms to further reduce the aromatic content of the composition.

In some embodiments, and in particular, in some embodiments where the feed to the process of the present invention comprises a polyethylene, a poly propylene, including but not limited to a high density polyethylene, a resulting noncondensable liquid product may comprise at least 45% by weight olefins, and 30 to 48% by weight paraffins, 0.5 to 7% by weight aromatics, and less than 2% by weight polynuclear aromatics. In some such embodiments, the olefins may be at least 60% alpha olefins, or alternatively at least 72% alpha olefins with a ratio of internal distributed olefins to vinylidene olefins, on a mole basis, of from 2.5 to 4.5; an alpha olefin to paraffin ration in the range of 1.1 to 1.9 for the C10 molecular fraction, 0.7 to 1.22 for the C8 fraction, 0.7 and 1.27 for the C9 fraction; and in which there is a peak in the olefin content as a function of carbon number in the carbon number range of 6 to 20. This composition has a high aromatic composition in the naphtha distillation range and a low aromatic content in the diesel fuel, providing a favorable stream for use in refinery applications, whether the diesel portion is used for fuel products, for olefin cracker feed, for lubricants or for extraction for conversion, for example, to detergent alcohols.

In some embodiments, and in particular, in some embodiments where the feed to the process of the present invention comprises a polyethyleneterephthalate, a resulting noncondensable liquid product may comprise between 45% and 85% by weight aromatics; a ratio of aromatics to alpha plus vinylidene olefins of at least 100:1; an API gravity of 10 to 20; a microcarbon residue of less than 0.3 weight percent; a sulfur content of less than 0.4%; an amount of diphenylketone of between 0.00001% and 4% by weight; an amount of benzoic acid between 0.1% and 30% by weight; and amount of toluic acid between 0.05% and 5% by weight; and with at least 20% of the hydrogen contained in the hydrocarbon composition being aliphatic hydrogen. Benzoic and toluic acid contents of such streams may be high enough (in some embodiments between 10 and 20% by weight) to permit isolation for sale. The diphenyl ketones may also be removed by extraction and distillation as a valuable product. A largely aromatic raffinate of the removal of the acids has very little reactive olefin, and is therefore stable. Its high density and low olefin content make it a valuable blending stock to improve the energy content of fuels. It is also a rich source of aromatics which is essentially free of Conradson carbon making it more valuable for high octane or high energy content fuel uses. The very low MCR level means that it may be processed further in traditional refinery processes with very little loss to coke, making it a valuable refinery feedstock. The low sulfur level (in some embodiments less than 0.05% by weight) makes it easy to process without hydrotreatment and improves its value as a fuel.

In some embodiments, the liquid product has a residue content of at most 70%, at most 50%, at most 30%, at most 10%, or at most 1% of the polymeric feed. In certain embodiments, the liquid product has, per gram of liquid product, a residue content of at most 0.1 grams, at most 0.05 grams, at most 0.03 grams, at most 0.02 grams, at most 0.01 grams, at most 0.005 grams, or at most 0.001 grams. In some embodiments, the liquid product has, per gram of liquid product, a residue content in a range from 0.000001 to 0.1 grams, 0.00001 to 0.05 grams, 0.001 to 0.03 grams, or 0.005 to 0.04 grams.

In some embodiments, the liquid product may include at least a portion of the catalyst. In some embodiments, a liquid product includes from greater than 0 grams, but less than 0.01 grams, 0.000001 to 0.001 grams, or 0.00001 to 0.0001 grams of catalyst per gram of liquid product. The catalyst may assist in stabilizing the liquid product during transportation and/or treatment in processing facilities. The catalyst may inhibit corrosion, inhibit friction, and/or increase water separation abilities of the liquid product. A liquid product that includes at least a portion of the catalyst may be further processed to produce lubricants and/or other commercial products.

The catalysts used in contacting the polymeric feed with a hydrogen source to produce the total product may assist in the reduction of the molecular weight of the polymeric feed. Not to be bound by theory, the catalyst in combination with the hydrogen source may reduce a molecular weight of components in the polymeric feed through the action of basic (Lewis basic or Brønsted-Lowry basic) and/or superbasic components in the catalyst. Examples of catalysts that may have Lewis base and/or Brønsted-Lowry base properties include catalysts described herein.

In some embodiments, the catalyst is an inorganic salt catalyst. The anion of the inorganic salt catalyst may include an inorganic compound, an organic compound, or mixtures thereof. The inorganic salt catalyst includes alkali metal carbonates, alkali metal hydroxides, alkali metal hydrides, alkali metal amides, alkali metal sulfides, alkali metal acetates, alkali metal oxalates, alkali metal formates, alkali metal pyruvates, alkaline-earth metal carbonates, alkaline-earth metal hydroxides, alkaline-earth metal hydrides, alkaline-earth metal amides, alkaline-earth metal sulfides, alkaline-earth metal acetates, alkaline-earth metal oxalates, alkaline-earth metal formates, alkaline-earth metal pyruvates, or mixtures thereof.

Inorganic salt catalysts include, but are not limited to, mixtures of: NaOH/RbOH/CsOH; KOH/RbOH/CsOH; NaOH/KOH/RbOH; NaOH/KOH/CsOH; K₂CO₃/Rb₂CO₃/Cs₂CO₃; Na₂O/K₂O/K₂CO₃; NaHCO₃/KHCO₃/Rb₂CO₃; LiHCO₃/KHCO₃/Rb₂CO₃; KOH/RbOH/CsOH mixed with a mixture of K₂CO₃/Rb₂CO₃/Cs₂CO₃; K₂CO₃/CaCO₃; K₂CO₃/MgCO₃; Cs₂CO₃/CaCO₃; Cs₂CO₃/CaO; Na₂CO₃/Ca(OH)₂; KH/CsCO₃; KOCHO/CaO; CsOCHO/CaCO₃; CsOCHO/Ca(OCHO)₂; NaNH₂/K₂CO₃/Rb₂O; K₂CO₃/CaCO₃/Rb₂CO₃; K₂CO₃/CaCO₃/Cs₂CO₃; K₂CO₃/MgCO₃/Rb₂CO₃; K₂CO₃/MgCO₃/Cs₂CO₃; or Ca(OH)₂ mixed with a mixture of K₂CO₃/Rb₂CO₃/Cs₂CO₃.

In some embodiments, the inorganic salt catalyst contains at most 0.00001 grams, at most 0.001 grams, or at most 0.01 grams of lithium, calculated as the weight of lithium, per gram of inorganic salt catalyst. The inorganic salt catalyst has, in some embodiments, from 0 grams, but less than 0.01 grams, 0.0000001-0.001 grams, or 0.00001-0.0001 grams of lithium, calculated as the weight of lithium, per gram of inorganic salt catalyst.

In certain embodiments, an inorganic salt catalyst includes one or more alkali metal salts that include an alkali metal with an atomic number of at least 11. An atomic ratio of an alkali metal having an atomic number of at least 11 to an alkali metal having an atomic number greater than 11, in some embodiments, is in a range from 0.1 to 10, 0.2 to 6, or 0.3 to 4 when the inorganic salt catalyst has two or more alkali metals. For example, the inorganic salt catalyst may include salts of sodium, potassium, and rubidium with the ratio of sodium to potassium being in a range from 0.1 to 6; the ratio of sodium to rubidium being in a range from 0.1 to 6; and the ratio of potassium to rubidium being in a range from 0.1 to 6. In another example, the inorganic salt catalyst includes a sodium salt and a potassium salt with the atomic ratio of sodium to potassium being in a range from 0.1 to 4.

In certain embodiments, the inorganic salt catalyst also includes metal oxides from Columns 1-2 and/or Column 13 of the Periodic Table. Metals from Column 13 include, but are not limited to, boron or aluminum. Non-limiting examples of metal oxides include lithium oxide (Li₂O), potassium oxide (K₂O), calcium oxide (CaO), or aluminum oxide (Al₂O₃).

The inorganic salt catalyst is, in certain embodiments, free of or substantially free of Lewis acids (for example, BCl₃, AlCl₃, and SO₃), Brønsted-Lowry acids (for example, H₃O+, H₂SO₄, HCl, and HNO₃), glass-forming compositions (for example, borates and silicates), and halides. The inorganic salt may contain, per gram of inorganic salt catalyst: from 0 grams to 0.1 grams, 0.000001 to 0.01 grams, or 0.00001 to 0.005 grams of: a) halides; b) compositions that form glasses at temperatures of at least 350° C., or at most 1000° C.; c) Lewis acids; d) Brønsted-Lowry acids; or e) mixtures thereof.

The inorganic salt catalyst may be prepared using standard techniques. For example, a desired amount of each component of the catalyst may be combined using standard mixing techniques (for example, milling and/or pulverizing). In other embodiments, inorganic compositions are dissolved in a solvent (for example, water or a suitable organic solvent) to form an inorganic composition/solvent mixture. The solvent may be removed using standard separation techniques to produce the inorganic salt catalyst.

In some embodiments, inorganic salts of the inorganic salt catalyst may be incorporated into a support to form a supported inorganic salt catalyst. Examples of supports include, but are not limited to, zirconium oxide, calcium oxide, magnesium oxide, titanium oxide, hydrotalcite, alumina, germania, iron oxide, nickel oxide, zinc oxide, cadmium oxide, antimony oxide, and mixtures thereof. In some embodiments, an inorganic salt, a Columns 6-10 metal and/or a compound of a Columns 6-10 metal may be impregnated in the support. Alternatively, inorganic salts may be melted or softened with heat and forced in and/or onto a metal support or metal oxide support to form a supported inorganic salt catalyst.

A structure of the inorganic salt catalyst typically becomes nonhomogenous, permeable, and/or mobile at a particular temperature or in a temperature range when loss of order occurs in the catalyst structure. The inorganic salt catalyst may become disordered without a substantial change in composition (for example, without decomposition of the salt). Not to be bound by theory, it is believed that the inorganic salt catalyst becomes disordered (mobile) when distances between ions in the lattice of the inorganic salt catalyst increase. As the ionic distances increase, a polymeric feed and/or a hydrogen source may permeate through the inorganic salt catalyst instead of across the surface of the inorganic salt catalyst. Permeation of the polymeric feed and/or hydrogen source through the inorganic salt often results in an increase in the contacting area between the inorganic salt catalyst and the polymeric feed and/or the hydrogen source. An increase in contacting area and/or reactivity area of the inorganic salt catalyst may often increase the yield of liquid product, limit production of residue and/or coke, and/or facilitate a change in properties in the liquid product relative to the same properties of the polymeric feed. Disorder of the inorganic salt catalyst (for example, nonhomogeneity, permeability, and/or mobility) may be determined using DSC methods, ionic conductivity measurement methods, TAP methods, visual inspection, x-ray diffraction methods, or combinations thereof. In some embodiments of the present invention, the catalyst is in such a disordered state, and is contacted with a polymeric feed while in the disordered state.

The use of TAP to determine characteristics of catalysts is described in U.S. Pat. No. 4,626,412 to Ebner et al.; U.S. Pat. No. 5,039,489 to Gleaves et al.; and U.S. Pat. No. 5,264,183 to Ebner et al. A TAP system may be obtained from Mithra Technologies (Foley, Mo., U.S.A.). The TAP analysis may be performed in a temperature range from 25 to 850° C., 50 to 500° C., or 60 to 400° C., at a heating rate in a range from 10 to 50° C., or 20 to 40° C., and at a vacuum in a range from 1×10⁻¹³ to 1×10⁻⁸ torr. The temperature may remain constant and/or increase as a function of time. As the temperature of the inorganic salt catalyst increases, gas emission from the inorganic salt catalyst is measured. Examples of gases that evolve from the inorganic salt catalyst include carbon monoxide, carbon dioxide, hydrogen, water, or mixtures thereof. The temperature at which an inflection (sharp increase) in gas evolution from the inorganic salt catalyst is detected is considered to be the temperature at which the inorganic salt catalyst becomes disordered.

In some embodiments, an inflection of emitted gas from the inorganic salt catalyst may be detected over a range of temperatures as determined using TAP. The temperature or the temperature range is referred to as the “TAP temperature”. The initial temperature of the temperature range determined using TAP is referred to as the “minimum TAP temperature”.

The emitted gas inflection exhibited by inorganic salt catalysts suitable for contact with a polymeric feed is in a TAP temperature range from 100 to 600° C., 200 to 500° C., or 300 to 400° C. Typically, the TAP temperature is in a range from 300 to 500° C. In some embodiments, different compositions of suitable inorganic salt catalysts also exhibit gas inflections, but at different TAP temperatures.

The magnitude of the ionization inflection associated with the emitted gas may be an indication of the order of the particles in a crystal structure. In a highly ordered crystal structure, the ion particles are generally tightly associated, and release of ions, molecules, gases, or combinations thereof, from the structure requires more energy (that is more heat). In a disordered crystal structure, ions are not associated to each other as strongly as ions in a highly ordered crystal structure. Due to the lower ion association, less energy is generally required to release ions, molecules, and/or gases from a disordered crystal structure, and thus, a quantity of ions and/or gas released from a disordered crystal structure is typically greater than a quantity of ions and/or gas released from a highly ordered crystal structure at a selected temperature.

In some embodiments, a heat of dissociation of the inorganic salt catalyst may be observed in a range from 50° C. to 500° C. at a heating rate or cooling rate of 10° C., as determined using a differential scanning calorimeter. In a DSC method, a sample may be heated to a first temperature, cooled to room temperature, and then heated a second time. Transitions observed during the first heating generally are representative of entrained water and/or solvent and may not be representative of the heat of dissociations. For example, easily observed heat of drying of a moist or hydrated sample may generally occur below 250° C., typically between 100 and 150° C. The transitions observed during the cooling cycle and the second heating correspond to the heat of dissociation of the sample.

“Heat transition” refers to the process that occurs when ordered molecules and/or atoms in a structure become disordered when the temperature increases during the DSC analysis. “Cool transition” refers to the process that occurs when molecules and/or atoms in a structure become more homogeneous when the temperature decreases during the DSC analysis. In some embodiments, the heat/cool transition of the inorganic salt catalyst occurs over a range of temperatures that are detected using DSC. The temperature or temperature range at which the heat transition of the inorganic salt catalyst occurs during a second heating cycle is referred to as “DSC temperature”. The lowest DSC temperature of the temperature range during a second heating cycle is referred to as the “minimum DSC temperature”. The inorganic salt catalyst may exhibit a heat transition in a range between 200 and 500° C., 250 and 450° C., or 300 and 400° C.

In an inorganic salt that contains inorganic salt particles that are a relatively homogeneous mixture, a shape of the peak associated with the heat absorbed during a second heating cycle may be relatively narrow. In an inorganic salt catalyst that contains inorganic salt particles in a relatively non-homogeneous mixture, the shape of the peak associated with heat absorbed during a second heating cycle may be relatively broad. An absence of peaks in a DSC spectrum indicates that the salt does not absorb or release heat in the scanned temperature range. Lack of a heat transition generally indicates that the structure of the sample does not change upon heating.

As homogeneity of the particles of an inorganic salt mixture increases, the ability of the mixture to remain a solid and/or a semiliquid during heating decreases. Homogeneity of an inorganic mixture may be related to the ionic radius of the cations in the mixtures. For cations with smaller ionic radii, the ability of a cation to share electron density with a corresponding anion increases and the acidity of the corresponding anion increases. For a series of ions of similar charges, a smaller ionic radius results in higher interionic attractive forces between the cation and the anion if the anion is a hard base. The higher interionic attractive forces tend to result in higher heat transition temperatures for the salt and/or more homogeneous mixture of particles in the salt (sharper peak and increased area under the DSC curve). Mixtures that include cations with small ionic radii tend to be more acidic than cations of larger ionic radii, and thus acidity of the inorganic salt mixture increases with decreasing cationic radii. For example, contact of a polymeric feed with a hydrogen source in the presence of an inorganic mixture that includes lithium cations tends to produce increased quantities of gas and/or coke relative to contact of the polymeric feed with a hydrogen source in the presence of an inorganic salt catalyst that includes cations with a larger ionic radii than lithium. The ability to inhibit generation of gas and/or coke increases the total liquid product yield of the process.

In certain embodiments, the inorganic salt catalyst may include two or more inorganic salts. A minimum DSC temperature for each of the inorganic salts may be determined. The minimum DSC temperature of the inorganic salt catalyst may be below the minimum DSC temperature of at least one of the inorganic metal salts in the inorganic salt catalyst. For example, the inorganic salt catalyst may include potassium carbonate and cesium carbonate. Potassium carbonate and cesium carbonate exhibit DSC temperatures greater than 500° C. A K₂CO₃/Rb₂CO₃/Cs₂CO₃ catalyst exhibits a DSC temperature in a range from 290 to 300° C.

In some embodiments, the TAP temperature may be between the DSC temperature of at least one of the inorganic salts and the DSC temperature of the inorganic salt catalyst. For example, the TAP temperature of the inorganic salt catalyst may be in a range from 350 to 500° C. The DSC temperature of the same inorganic salt catalyst may be in a range from 200 to 300° C., and the DSC temperature of the individual salts may be at least 500° C. or at most 1000° C.

An inorganic salt catalyst that has a TAP and/or DSC temperature between 150 and 500° C., 200 and 450° C., or 300 and 400° C., and does not undergo decomposition at these temperatures, in many embodiments, can be used to catalyze conversion of high molecular weight and/or high viscosity compositions (for example, polymeric feed) to liquid products.

In certain embodiments, the inorganic salt catalyst may exhibit increased conductivity relative to individual inorganic salts during heating of the inorganic salt catalyst in a temperature range from 200 and 600° C., 300 and 500° C., or 350 and 450° C. Increased conductivity of the inorganic salt catalyst is generally attributed to the particles in the inorganic salt catalyst becoming mobile. The ionic conductivity of some inorganic salt catalysts changes at a lower temperature than the temperature at which ionic conductivity of a single component of the inorganic salt catalyst changes.

Ionic conductivity of inorganic salts may be determined by applying Ohm's law: V=IR, where V is voltage, I is current, and R is resistance. To measure ionic conductivity, the inorganic salt catalyst may be placed in a quartz vessel with two wires (for example, copper wires or platinum wires) separated from each other, but immersed in the inorganic salt catalyst.

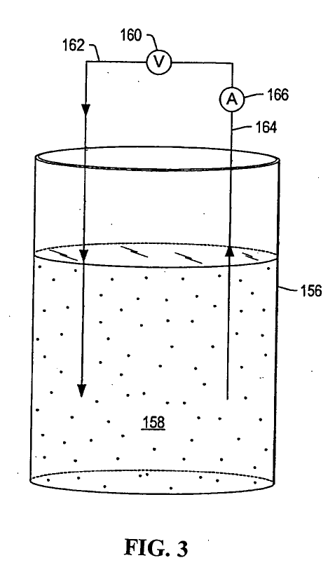

FIG. 3 is a schematic of a system that may be used to measure ionic conductivity. Quartz vessel 156 containing sample 158 may be placed in a heating apparatus and heated incrementally to a desired temperature. Voltage from source 160 is applied to wire 162 during heating. The resulting current through wires 162 and 164 is measured at meter 166. Meter 166 may be, but is not limited to, a multimeter or a Wheatstone bridge. As sample 158 becomes less homogeneous (more mobile) without decomposition occurring, the resistivity of the sample should decrease and the observed current at meter 166 should increase.

In some embodiments, at a desired temperature, the inorganic salt catalyst may have a different ionic conductivity after heating, cooling, and then heating. The difference in ionic conductivities may indicate that the crystal structure of the inorganic salt catalyst has been altered from an original shape (first form) to a different shape (second form) during heating. The ionic conductivities, after heating, are expected to be similar or the same if the form of the inorganic salt catalyst does not change during heating.

In certain embodiments, the inorganic salt catalyst has a particle size in a range of 10 to 1000 microns, 20 to 500 microns, or 50 to 100 microns, as determined by passing the inorganic salt catalyst through a mesh or a sieve.

The inorganic salt catalyst may soften when heated to temperatures above 50° C. and below 500° C. As the inorganic salt catalyst softens, liquids and catalyst particles may co-exist in the matrix of the inorganic salt catalyst. The catalyst particles may, in some embodiments, self-deform under gravity, or under a pressure of at least 0.007 MPa, or at most 0.101 MPa, when heated to a temperature of at least 300° C., or at most 800° C., such that the inorganic salt catalyst transforms from a first form to a second form. Upon cooling of the inorganic salt catalyst to 20° C., the second form of the inorganic salt catalyst is incapable of returning to the first form of the inorganic salt catalyst. The temperature at which the inorganic salt transforms from the first form to a second form is referred to as the “deformation” temperature. The deformation temperature may be a temperature range or a single temperature. In certain embodiments, the particles of the inorganic salt catalyst self-deform under gravity or pressure upon heating to a deformation temperature below the deformation temperature of any of the individual inorganic metal salts. In some embodiments, an inorganic salt catalyst includes two or more inorganic salts that have different deformation temperatures. The deformation temperature of the inorganic salt catalyst differs, in some embodiments, from the deformation temperatures of the individual inorganic metal salts.

In certain embodiments, the inorganic salt catalyst is liquid and/or semiliquid at, or above, the TAP and/or DSC temperature. In some embodiments, the inorganic salt catalyst is a liquid or a semiliquid at the minimum TAP and/or DSC temperature. At or above the minimum TAP and/or DSC temperature, liquid or semiliquid inorganic salt catalyst mixed with the polymeric feed may, in some embodiments, form a separate phase from the polymeric feed. In some embodiments, the liquid or semiliquid inorganic salt catalyst has low solubility in the polymeric feed (for example, from 0 grams to 0.5 grams, 0.0000001 to 0.2 grams, or 0.0001 to 0.1 grams of inorganic salt catalyst per gram of polymeric feed) or is insoluble in the polymeric feed (for example, from 0 grams to 0.05 grams, 0.000001 to 0.01 grams, or 0.00001 to 0.001 grams of inorganic salt catalyst per gram of polymeric feed) at the minimum TAP temperature.

In some embodiments, powder x-ray diffraction methods are used to determine the spacing of the atoms in the inorganic salt catalyst. A shape of the D₀₀₁ peak in the x-ray spectrum may be monitored and the relative order of the inorganic salt particles may be estimated. Peaks in the x-ray diffraction represent different compounds of the inorganic salt catalyst. In powder x-ray diffraction, the D₀₀₁ peak may be monitored and the spacing between atoms may be estimated. In an inorganic salt catalyst that contains highly ordered inorganic salt atoms, a shape of the D₀₀₁ peak is relatively narrow. In an inorganic salt catalyst (for example, a K₂CO₃/Rb₂CO₃/Cs₂CO₃ catalyst) that contains randomly ordered inorganic salt atoms, the shape of the D₀₀₁ peak may be relatively broad or the D₀₀₁ peak may be absent. To determine if the disorder of inorganic salt atoms changes during heating, an x-ray diffraction spectrum of the inorganic salt catalyst may be taken before heating and compared with an x-ray diffraction spectrum taken after heating. The D₀₀₁ peak (corresponding to the inorganic salt atoms) in the x-ray diffraction spectrum taken at temperatures above 50° C. may be absent or broader than the D₀₀₁ peaks in the x-ray diffraction spectrum taken at temperatures below 50° C. Additionally, the x-ray diffraction pattern of the individual inorganic salt may exhibit relatively narrow D₀₀₁ peaks at the same temperatures.

The instant invention includes in another embodiment, a novel process of catalytic decomposition of rubbers, plastics, tires, and other polymeric materials, either thermoset or thermoplastic, which uses the catalytic chemistry of strong bases to achieve novel reaction products, improved yields of valuable liquid products, and improved rates of production of valuable liquid products. As a particular embodiment of the invention, strong basic character of the basic catalyst system is maintained during the reaction, for example by limiting the amount of chlorine and other acids admitted to the reactor to a small fraction of the total amount of base present. Bases which are molten at the reaction temperature, such as eutectics of mixed alkali metal hydroxides and carbonates are especially useful in some embodiments of the instant invention, due to their ability to intimately mix with the reacting materials at high temperature and provide high rates of catalysis.

Contacting conditions may be controlled such that the total product composition (and thus, the liquid product) may be varied for a given polymeric feed in addition to limiting and/or inhibiting formation of by-products. The total product composition includes, but is not limited to, paraffins, olefins, aromatics, or mixtures thereof. These compounds make up the compositions of the liquid product and the non-condensable hydrocarbon gases.

In some embodiments, the residue content and/or coke content deposited on the catalyst during a reaction period may be at most 0.1 grams, at most 0.05 grams, or at most 0.03 grams of residue and/or coke per gram of catalyst. In certain embodiments, the weight of residue and/or coke deposited on the catalyst is in a range from 0.0001 to 0.1 grams, 0.001 to 0.05 grams, or 0.01 to 0.03 grams. In some embodiments, used catalyst is substantially free of residue and/or coke. In certain embodiments, contacting conditions are controlled such that at most 0.015 grams, at most 0.01 grams, at most 0.005 grams, or at most 0.003 grams of coke is formed per gram of liquid product. Contacting a polymeric feed with the catalyst under controlled contacting conditions produces a reduced quantity of coke and/or residue relative to a quantity of coke and/or residue produced by heating the polymeric feed in the presence of a refining catalyst, or in the absence of a catalyst, using the same contacting conditions.

The contacting conditions may be controlled, in some embodiments, such that, per gram of polymeric feed, at least 0.5 grams, at least 0.7 grams, at least 0.8 grams, or at least 0.9 grams of the polymeric feed is converted to the liquid product. Typically, between 0.5 and 0.99 grams, 0.6 and 0.9 grams, or 0.7 and 0.8 grams of the liquid product per gram of polymeric feed is produced during contacting. Conversion of the polymeric feed to a liquid product with a minimal yield of residue and/or coke, if any, in the liquid product allows the liquid product to be converted to commercial products with a minimal amount of pre-treatment at a refinery. In certain embodiments, and in particular, when the polymer feed is a polyethylene, per gram of polymeric feed, at most 0.25 grams, at most 0.15 grams, at most 0.07 grams, at most 0.03 grams, or at most 0.01 grams of the polymeric feed is converted to non-condensable hydrocarbons. In some embodiments, from 0 to 0.25 grams, 0.0001-0.15 grams, 0.001-0.07 grams, or 0.01-0.03 grams of non-condensable hydrocarbons per gram of polymeric feed is produced. In certain embodiments, and in particular when the polymer feed is a polyethyleneterephthalate, per gram of polymeric feed, at most 0.1 grams, at most 0.07 grams, at most 0.05 grams, at most 0.03 grams, or at most 0.01 grams of the polymeric feed is converted to non-condensable hydrocarbons. In some embodiments, from 0 to 0.1 grams, 0.0001-0.07 grams, 0.001-0.03 grams, or 0.001-0.01 grams of non-condensable hydrocarbons per gram of polymeric feed is produced.

Controlling a contacting zone temperature, rate of polymeric feed flow, rate of total product flow, rate and/or amount of catalyst feed, or combinations thereof, may be performed to maintain desired reaction temperatures. In some embodiments, control of the temperature in the contacting zone may be performed by changing a flow of a gaseous hydrogen source and/or inert gas through the contacting zone to dilute the amount of hydrogen and/or remove excess heat from the contacting zone.

In some embodiments, the temperature in the contacting zone may be controlled such that a temperature in the contacting zone is at, above, or below desired temperature “T₁”. In certain embodiments, the contacting temperature is controlled such that the contacting zone temperature is below the minimum TAP temperature and/or the minimum DSC temperature. In certain embodiments, T₁ may be 30° C. below, 20° C. below, or 10° C. below the minimum TAP temperature and/or the minimum DSC temperature. For example, in one embodiment, the contacting temperature may be controlled to be 370° C., 380° C., or 390° C. during the reaction period when the minimum TAP temperature and/or minimum DSC temperature is 400° C.

In other embodiments, the contacting temperature is controlled such that the temperature is at, or above, the catalyst TAP temperature and/or the catalyst DSC temperature. For example, the contacting temperature may be controlled to be 450° C., 500° C., or 550° C. during the reaction period when the minimum TAP temperature and/or minimum DSC temperature is 450° C. Controlling the contacting temperature based on catalyst TAP temperatures and/or catalyst DSC temperatures may yield improved liquid product properties. Such control may, for example, decrease coke formation, decrease non-condensable gas formation, or combinations thereof.

In certain embodiments, the inorganic salt catalyst may be conditioned prior to addition of the polymeric feed. In some embodiments, the conditioning may take place in the presence of the polymeric feed. Conditioning the inorganic salt catalyst may include heating the inorganic salt catalyst to a first temperature of at least 100° C., at least 300° C., at least 400° C., or at least 500° C., and then cooling the inorganic salt catalyst to a second temperature of at most 250° C., at most 200° C., or at most 100° C. In certain embodiments, the inorganic salt catalyst is heated to a temperature in a range from 150 to 700° C., 200 to 600° C., or 300 to 500° C., and then cooled to a second temperature in a range from 25 to 240° C., 30 to 200° C., or 50 to 90° C. The conditioning temperatures may be determined by determining ionic conductivity measurements at different temperatures. In some embodiments, conditioning temperatures may be determined from DSC temperatures obtained from heat/cool transitions obtained by heating and cooling the inorganic salt catalyst multiple times in a DSC. Conditioning of the inorganic salt catalyst may allow contact of a polymeric feed to be performed at lower reaction temperatures than temperatures used with conventional hydrotreating catalysts.

In some embodiments, the contacting conditions may be changed over time. For example, the contacting pressure and/or the contacting temperature may be increased to increase the amount of hydrogen that the polymeric feed uptakes to produce the liquid product. The ability to change the amount of hydrogen uptake of the polymeric feed, while improving other properties of the polymeric feed, increases the types of liquid products that may be produced from a single polymeric feed. The ability to produce multiple liquid products from a single polymeric feed may allow different transportation and/or treatment specifications to be satisfied.

Uptake of hydrogen may be assessed by comparing H/C of the polymeric feed to H/C of the liquid product and doing a hydrogen balance between the feed and all of the products. An increase in the H/C of the liquid product relative to H/C of the polymeric feed indicates incorporation of hydrogen into the liquid product from the hydrogen source. Relatively low increase in H/C of the liquid product (20%, as compared to the polymeric feed) indicates relatively low consumption of hydrogen gas during the process. Significant improvement of the liquid product properties, relative to those of the polymeric feed, obtained with minimal consumption of hydrogen is desirable.

The ratio of hydrogen source to polymeric feed may also be altered to alter the properties of the liquid product. For example, increasing the ratio of the hydrogen source to polymeric feed may result in liquid product that has an increased VGO content per gram of liquid product.

In certain embodiments, contact of the polymeric feed with the inorganic salt catalyst in the presence of light hydrocarbons and/or steam yields more liquid hydrocarbons and less coke in a liquid product than contact of a polymeric feed with an inorganic salt catalyst in the presence of hydrogen and steam. In embodiments that include contact of the polymeric feed with methane in the presence of the inorganic salt catalyst, at least a portion of the components of the liquid product may include atomic carbon and hydrogen (from the methane) which has been incorporated into the molecular structures of the components.

In some embodiments, the inorganic salt catalyst can be regenerated, at least partially, by removal of one or more components that contaminate the catalyst. Contaminants include, but are not limited to, metals, sulfides, nitrogen, coke, or mixtures thereof. Sulfide contaminants may be removed from the used inorganic salt catalyst by contacting steam and carbon dioxide with the used catalyst to produce hydrogen sulfide. Nitrogen contaminants may be removed by contacting the used inorganic salt catalyst with steam to produce ammonia. Coke contaminants may be removed from the used inorganic salt catalyst by contacting the used inorganic salt catalyst with steam and/or methane to produce hydrogen and carbon oxides. In some embodiments, one or more gases are generated from a mixture of used inorganic salt catalyst and residual polymeric feed.

In certain embodiments, a mixture of used inorganic salt (for example, K₂CO₃/Rb₂CO₃/Cs₂CO₃; KOH/Al₂O₃; Cs₂CO₃/CaCO₃; or NaOH/KOH/LiOH/ZrO₂), unreacted polymeric feed and/or residue and/or coke may be heated to a temperature in a range from 700-1000° C. or from 800-900° C. until the production of gas and/or liquids is minimal in the presence of steam, hydrogen, carbon dioxide, and/or light hydrocarbons to produce a liquid phase and/or gas. The gas may include an increased quantity of hydrogen and/or carbon dioxide relative to reactive gas. For example, the gas may include from 0.1 to 99 moles or from 0.2 to 8 moles of hydrogen and/or carbon dioxide per mole of reactive gas. The gas may contain a relatively low amount of light hydrocarbons and/or carbon monoxide. For example, less than 0.05 grams of light hydrocarbons per gram of gas and less than 0.01 grams of carbon monoxide per gram of gas. The liquid phase may contain water, for example, greater than 0.5 to 0.99 grams, or greater than 0.9 to 0.9 grams of water per gram of liquid.

In some embodiments, the used catalyst and/or solids in the contacting zone may be treated to recover metals (for example, vanadium and/or nickel) from the used catalyst and/or solids. The used catalyst and/or solids may be treated using generally known metal separation techniques, for example, heating, chemical treating, and/or gasification.

As a particular embodiment, the process also incorporates hydrogen catalytically into the reaction products by producing hydrogen in situ in the reactor as desired by reforming light hydrocarbon gases in the presence of steam to produce carbon oxides and hydrogen, some of which hydrogen is incorporated into the products of the reaction.

Embodiments of the present process produces chemicals and fuels with greater yield and with properties that are desirable. Operation of the instant invention in some embodiments, allows a greater yield of desired products, for example, an increase in the liquid to solid product ratio from plain glass belted tires of a factor of 1.4 over that obtained by pyrolysis at identical temperature without the catalytic system present.

The technology of the instant invention further allows control over the nature of the valuable products produced by a simple means, for example by control of the pressure at which the catalytic depolymerization is carried out, or by control of the flow of reagents into the catalytic reactor.

The instant invention therefore provides a significant improvement over the prior art by allowing an increase in the yield of valuable products (typically liquids), control over the chemical nature and molecular weight of the products according to market needs, increase in rates of reaction, and catalytic transformation of the products, including the addition of hydrogen and isomerization to more valuable species.

### EXAMPLES

Non-limiting examples of catalyst preparations, testing of catalysts, and systems with controlled contacting conditions are set forth below.

Contact of a Polymeric Feed—General Procedures. The following equipment and general procedure was used in the Examples except where variations are described.

Reactor: A 250 mL Hastelloy C Parr Autoclave (Parr Model #4576) rated at 35 MPa working pressure (5000 psi) at 500° C., was fitted with a mechanical stirrer and an 800 watt Gaumer band heater on a Eurotherm controller capable of maintaining the autoclave at ±5° C. from ambient to 625° C., a gas inlet port, a steam inlet port, one outlet port, and a thermocouple to register internal temperature. Prior to heating, the top of the autoclave was insulated with glass cloth.

Product Collection: Vapor from the reactor exited the outlet port of the reactor and was introduced into a series of cold traps of decreasing temperatures (dip tubes connected to a series of 150 mL, 316 stainless steel hoke vessels). Liquid from the vapor was condensed in the cold traps to form a gas stream and a liquid condensate stream. Flow rate of the vapor from the reactor and through the cold traps was regulated, as needed. A rate of flow and a total gas volume for the gas stream exiting the cold traps were measured using a wet test meter (Ritter Model # TG 05 Wet Test Meter). After exiting the wet test meter, the gas stream was collected in a gas bag (a Tedlar gas collection bag) for analysis. The gases were tested by Agilent RGA analyzers. The liquid condensate stream was removed from the cold traps and weighed. Organic product and water were separated from the liquid condensate stream. The product was weighed and analyzed. The liquid was analyzed using GC/MS (Hewlett-Packard Model 5890, now Agilent Model 5890; manufactured by Agilent Technologies, Zion Ill., U.S.A.). The boiling point distributions of the samples were determined by High Temperature Simulated Distillation (HTSD). 13C Nuclear Magnetic Resonance (NMR) was used to determine the relative amounts of aromatic and internal olefin carbons (combined, since 13C NMR does not resolve these two species separately), alpha olefin carbons, vinylidene carbons and aliphatic carbons of various samples on a Bruker Avance-500 spectrometer using the 45-degree pulse-and-acquire sequence with proton decoupling. 1H NMR was used to determine the relative amounts of aromatic, olefininc, and aliphatic hydrogens. 1H NMR was further used to separate the olefinic hydrogens into, alpha, vinylidene, disubstituted internal, and trisubstituted internal double bonds. 1H NMR measurements were conducted on a Varian Inova-500 spectrometer using the 30-degree pulse-and-acquire sequence.

Preparation of K₂CO₃/Rb₂CO₃/Cs₂CO₃ Catalyst

In the Examples, where a catalyst was used, the catalyst was prepared according to the following procedure: A catalyst containing a mixture of K₂CO₃/Rb₂CO₃/Cs₂CO₃ was prepared by combining 27.58 wt. % of K₂CO₃, 32.17 wt. % of Rb₂CO₃, and 40.25 wt. % of Cs₂CO₃. The K₂CO₃/Rb₂CO₃/Cs₂CO₃ catalyst was tested according to the procedures provided in Examples 11-14. The K₂CO₃/Rb₂CO₃/Cs₂CO₃ catalyst had a minimum TAP temperature of 360° C. The K₂CO₃/Rb₂CO₃/Cs₂CO₃ catalyst had a DSC temperature of 250° C. The individual salts (K₂CO₃, Rb₂CO₃, and Cs₂CO₃) did not exhibit DSC temperatures in a range from 50-500° C. This TAP temperature is above the DSC temperature of the inorganic salt catalyst and below the DSC temperature of the individual metal carbonates.

### Examples 1-2

### Contact of a Waste Tire Feed with a Hydrogen Source in the Presence of a K₂CO₃/Rb₂CO₃/Cs₂CO₃ Catalyst and Steam

The reaction equipment and general procedures in Examples 1-65 were the same as described above except where variations are described below.

In Example 1, 63.1 g of K₂CO₃/Rb₂CO₃/Cs₂CO₃ catalyst, and 105.3 g of tire pieces (1″ square pieces of non-steel belted tire manufactured by Armstrong Tire Co.) were charged into the Hastelloy C 250 ml autoclave reactor. The reactor was connected to a steam generator, a gas feed line, and a vent line. The vent line was provided with two cold traps in series (room temperature and 0° C. respectively). An additional 0° C. cold trap packed with silicon carbide for mist removal was provided in the vent line after these traps. The gas outlet of the demisting cold trap was connected to a wet test meter to monitor gas volume. Gas vented from the wet test meter was collected in gas sampling bags. After nitrogen gas purging of the system for about 15 minutes, feed of methane was started at about 250 m/min. Then 20 minutes later, the reactor was heated over a 2 hour time interval up to 500° C. at atmospheric pressure. Agitation was started at 300° C. during heat-up. When the reactor reached 500° C., water was fed to the steam generator at a rate of about 0.4 ml/min., and the resultant steam together with the methane was fed to the reactor for 2 hours. A total of 46.3 g of steam was fed to the reactor. The heating and stirring was then turned off. The reactor was cooled down to room temperature. A total of 41.4 L of gas was collected in the gas sampling bags. Gas in the gas sampling bags was analyzed by GC. A red brown organic liquid (49.44 g) and a yellow aqueous solution (40.60 g) were obtained from the room temperature trap. A brown organic liquid (3.00 g) and a colorless aqueous solution (1.03 g) were obtained from the 0° C. trap, and 1.10 g of unrecovered material was trapped in the demisting trap. API gravity of the organic liquid layer in the room temperature trap was 18.43. A total of 101.3 g of dark grey or black solids containing fibers was retrieved from the reactor. Samples were analyzed by HTSD, GC/MS, elemental, ¹³C NMR, and ¹H NMR analysis.

The tire samples used in this experiment, and the experiments and controls below which use non-steel belted tires contained about 48% by weight rubber, about 30% by weight carbon black and fillers, about 12% by weight glass belts, and about 10% by weight Nylon or polylesters. The rubber was 67% by weight polyisoprene, and 33% by weight styrene-butadiene rubber with about a 3:1 ration of butadiene to styrene.

In Experiment 2 the reaction was carried out in the same manner as during Experiment 1 except for charging of 62.6 g of the carbonate salt catalyst mixture, charging of 106.6 g of 1″ square pieces of steel belted tire (trade name=AMER1-WAY XT, size=P215/65R15, manufactured by Continental Tire North America, Inc.), and no use of agitation. A total of 34.4 L of gas was collected in the gas sampling bags. A dark brown organic liquid (50.18 g) and a yellow aqueous solution (35.45 g) were obtained from the room temperature trap. A red brown organic liquid (2.00 g) and a yellow aqueous solution (1.21 g) were obtained from the 0° C. trap, and 1.53 g of unrecovered material was trapped in the demisting trap. A total of 111.4 g of solids was retrieved from the reactor as a black to grey powder and solids plus pieces of wire. API gravity of the organic liquid layer in the room temperature trap was 20.62. Samples were analyzed by HTSD, GC/MS, elemental, ¹³C NMR, and ¹H NMR analysis.

### Examples 3-4

### Contact of a Waste Tire Feed with a Hydrogen Source in the Presence of a SiC control and Steam

In Experiment 3, the reaction was carried out in the same manner as during Experiment 1 except for charging of 60.6 g of silicon carbide and 109.6 g of 1″ square pieces of non-steel belted tire. A total of 51.9 L of gas was collected in the gas sampling bags. A dark brown organic liquid (60.61 g) and a cloudy yellow aqueous solution (33.84 g) were obtained from the room temperature trap. A dark brown organic liquid (3.03 g) and a yellow aqueous solution (1.39 g) were obtained from the 0° C. trap, and 1.79 g of brown organic liquid was obtained from the demisting trap. A total of 100.6 g of solids containing fibers was retrieved from the reactor as a black powder or solid. API gravity of the organic liquid layer in the room temperature trap was 19.19. Samples were analyzed by HTSD, GC/MS, elemental, ¹³C NMR, and ¹H NMR analysis.

In Experiment 4, the reaction was carried out in the same manner as during Experiment 1 except for charging of 60.5 g of silicon carbide and 105.8 g of 1″ square pieces of non-steel belted tire. A total of 24.2 L of gas was collected in the gas sampling bags. A dark brown organic liquid (41.9 g) and a yellow aqueous solution (1.28 g) was obtained from the room temperature trap. A dark brown organic liquid (1.56 g) and a yellow aqueous solution (0.96 g) were obtained from the 0° C. trap, and 1.22 g of dark brown organic liquid was obtained from the demisting trap. A total of 104.9 g of solids containing white fibers was retrieved from the reactor as a black powder or solid. API gravity of the organic liquid layer in the room temperature trap was 23.04. Samples were analyzed by HTSD, GC/MS, elemental, ¹³C NMR, and ¹H NMR analysis.

TABLE 1
Comparison of use of salt mixture K₂CO₃/Rb₂CO₃/Cs₂CO₃
catalyst versus silicon carbide (Control) catalyst during treatment
of non-steel belted tire material.

| | Experiment 1 | Experiment 4 |
|---|---|---|
| Catalyst/Noncatalytic material | carbonate salt mix | SiC |
| Recovery of condensed phases: | 87% | 84% |
| Product solids yield (wt. %, tire | 36.3% | 42% |
| feed basis) (Weight of charged | | |
| catalyst was subtracted from | | |
| weight of recovered solids) | | |
| Organic liquid yield (wt. %, tire | 51% | 42% |
| feed basis) (From the room temper- | | |
| ature cold trap and the | | |
| 0° C. trap) | | |
| API of organic liquid product | 18.4 | 23.04 |
| in room temp. trap | | |
| Ratio of liquid to solid product: | 1.4 | 1 |

TABLE 2
Comparison of use of salt mixture K₂CO₃/Rb₂CO₃/Cs₂CO₃
catalyst versus silicon carbide (Control) catalyst during
treatment of non-steel belted tire material

| Experiment No. | 1 | 2 | 3 |
|---|---|---|---|
| Catalyst/Noncatalytic | K₂CO₃/Rb₂CO₃/Cs₂CO₃ | K₂CO₃/Rb₂CO₃/Cs₂CO₃ | SiC |
| material | | | Comparative |
| % Carbon Assay | | | |
| Aromatic + internal | 37.9 | 35.6 | 59.5 |
| olefin carbons % | | | |
| Aliphatic olefin & | 1.9 | 0.4 | 0.6 |
| vinylidene carbons % | | | |
| Aliphatic carbons % | 60.2 | 64.0 | 39.8 |
| % Hydrogen Assay | | | |
| Aromatic hydrogens | 10.1 | 8.1 | 23.3 |
| % | | | |
| Olefinic hydrogens | 1.5 | 2.1 | 1.0 |
| % | | | |
| Aliphatic hydrogens | 88.5 | 89.8 | 75.8 |
| % | | | |
| Double Bond | | | |
| Breakdown | | | |
| AO double bonds | 23.7 | 14.6 | 42.8 |
| IO disub double | 36.9 | 35.6 | 21.9 |
| bonds | | | |
| IO trisurb double | 17.6 | 22.6 | 12.5 |
| bonds | | | |
| VD double bonds | 21.9 | 27.3 | 22.8 |

TABLE 3
Gaseous Products-Tires

| Experiment | 1 | 2 | 3 |
|---|---|---|---|
| Catalyst/Noncatalytic | K₂CO₃/Rb₂CO₃/ | K₂CO₃/Rb₂CO₃/ | SiC |
| material | Cs₂CO₃ | Cs₂CO₃ | |
| Linear Olefins | 0.68 | 0.38 | 0.26 |
| Alpha/Beta | | | |
| Total Moles of C2+ | 0.02 | 0.01 | 0.03 |
| Gas Cracked | | | |
| CH₄ Including | 0.45 | 0.49 | 0.93 |
| Reforming, Moles | | | |
| Moles of CH₄ | 0.00 | 0.04 | 0.48 |
| Cracked | | | |
| Moles of Total | 0.02 | 0.05 | 0.52 |
| Cracked Gas | | | |

TABLE 4
Liquid Products - Tires

| | Relative Areas | Relative Areas |
|---|---|---|
| | Experiment 3 | Experiment 1 |
| Compound | SiC Control | Catalyst |
| Benzene | 1.0 | 0.0 |
| Toluene | 1.0 | 0.4 |
| C2 Benzene (Ethyl Benzene) | 1.0 | 1.6 |
| C2 Benzene (xylene) | 1.0 | 0.3 |
| Styrene | 1.0 | 1.9 |
| C2 Benzene (xylene) | 1.0 | 0.2 |
| n-propyl benzene | 1.0 | 2.3 |
| Limonene | 0.0 | 1.0 |
| n-butyl benzene | 1.0 | 2.7 |
| naphthalene | 1.0 | 0.2 |
| 1H-Indene, 2,3-dihydro-2,2-dimethyl | 1.0 | 0.7 |
| Phenanthrene or Anthracene | 1.0 | 0.2 |
| Phenanthrene or Anthracene | 1.0 | 0.2 |
| octadecanenitrile | 0.0 | 1.0 |

Table 4 above shows that catalytic decomposition using catalyst of the present invention results in 1.6 times more ethyl benzene, 1.9 times more styrene, 2.3 times more propyl benzene, and 2.7 times more butyl benzene, all commercially valuable chemical products, relative to the amount found from pyrolysis (Control). Less desired aromatics such as benzene, phenanthrene, indenes, and anthracene are significantly reduced in product of the catalytic process of an embodiment of the instant invention (Experiment 1). Potentially valuable chemicals, such as limonene (odor element of lemons) and octadecanenitrile, are produced only by the catalytic process. Therefore, product value is increased and toxicity is reduced and the product of this embodiment of the instant invention has increased value not only for fuel applications but as a source of chemical intermediates, or a feedstock for other chemical processes such as olefins production.

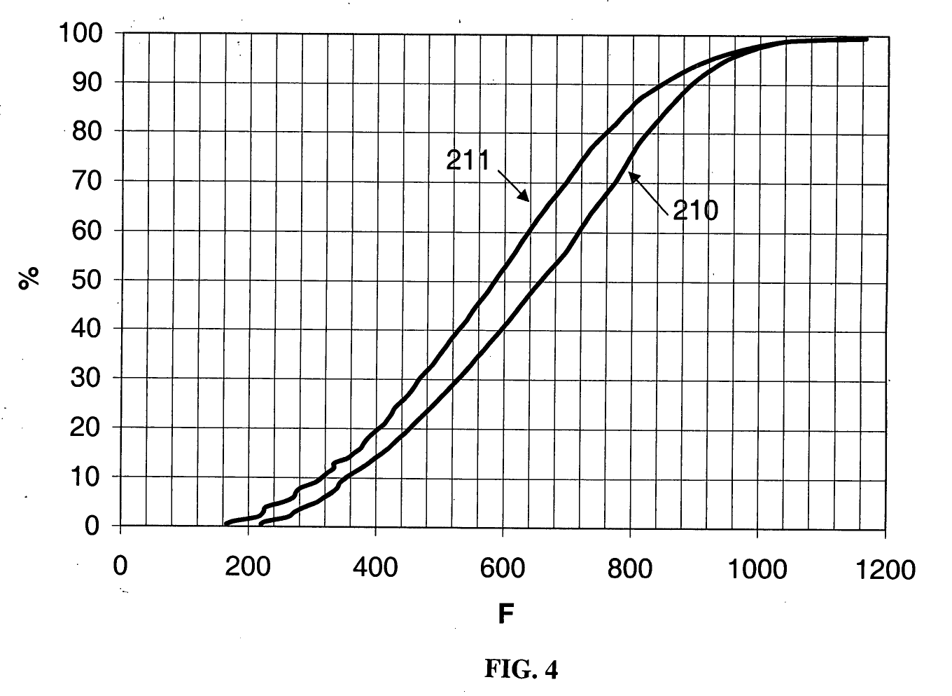

Referring now to FIG. 4, the catalytic control exerted over the decomposition of tires may be seen further by plotting the distillation curves of the products of the process utilizing the catalyst, 210, and the Control, 211. The overall control of the decomposition process by the catalytic process is indicated by the higher boiling point of the product oil at a given weight % distilled. In other words, the catalytic process cleaves larger (higher boiling) chunks off the polymer chain, giving a high rate of decomposition and depolymerization than the Control. which produces lighter products. This suggests that the catalytic product is liberated faster and resulting in more liquid products than the pyrolytic product.

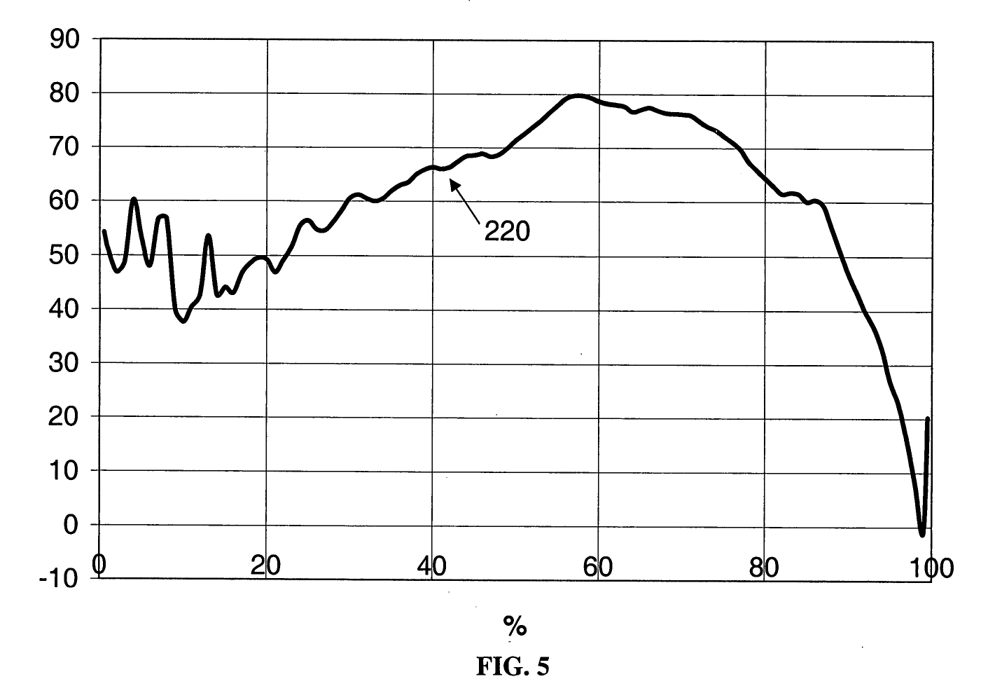

Referring now to FIG. 5, the difference in temperature between the two distillation curves of FIG. 4 is shown in ° F. as a function of the percent distilled, line 220. This makes it easier to see the increase in the boiling points of the two products.

From FIG. 5, it is apparent that although 99% of the material has distilled off by the same temperature, the average distillation temperature for the catalytic product is about 35° C. (60° F.) higher than for the pyrolytic product, indicating the higher carbon number of the catalytic products over most of the distillation curve (the end points being comparable).

From Table 4 is is also apparent that the control experiment resulted in a significant portion of the carbon atoms tied up as aromatic or internal olefin carbons (595%) whereas reaction in the presence of the carbonate salts from Example 1 had only considerably less aromatic or internal olefin carbons (37.9%). It should be noted that Example 1 used the same tire material as Example 3, whereas Example 2 used a different tire material. The differences between the aromatic plus internal olefin carbons mostly shows up as aliphatic carbons. This dramatic shift from aromatic to aliphatic compounds reflects a liquid hydrocarbon product that is of considerably more value. The olefin distribution of the product created in the presence of the carbonate salts is also shown to have more olefin bonds as internal substituted bonds.

### Examples 5-7

### Contact of a Waste High Density Polyethylene Milk Container Feed with a Hydrogen Source in the Presence of a K₂CO₃/Rb₂CO₃/Cs₂CO₃ Catalyst and Steam at Three Different Pressures

In Experiment 5 (atmospheric pressure), a feed of small pieces (approximately 1″ square pieces) of a reclyclable milk plastic bottle made of high density polyethylene (33.47 grams) and K₂CO₃/Rb₂CO₃/Cs₂CO₃ catalyst (63.17 grams), as described above, were charged to the reactor.

The mixture of catalyst and the feed was heated rapidly in about two hours to 500° C. under an atmospheric pressure flow of methane of 250 cm³/min. Stirring at approximately 300 rpm was initiated during the heat-up after the temperature reached approximately 280° C. After reaching the desired reaction temperature of 500° C., water at a rate of 0.4 mL/min, which equates to about 300 cc/minute of steam), and methane at rate of 250 cm³/min, were metered to the reactor for two hours. Immediately after 45.39 cc of water had been metered in (which was approximately 2 hours after the start of the metering of water), the heating was turned off. The reactor was cooled down to room temperature. 24.4 liters of gas was collected in the gas bags and analyzed by Gas Chromatography. A total of 74.31 grams of liquid was collected which include 38.49 grams of cloudy white aqueous solution and 35.82 grams of organic liquid obtained from the three traps, which came from the black and yellow organic snot collected in the room temperature Trap 1, 1.69 grams of pale yellow liquid collected in the 0° C. Trap 2, and 0.4 grams of organic liquid in the demisting Trap 3 (w/SiC in it 0° C.). 60.8 grams of white, grey and black solid was recovered from the reactor.

In Experiment 6, the reaction was carried out in the same manner as during Experiment 5 except a feed of 50.67 grams of small pieces (approximately 1″ square pieces) of a reclyclable milk plastic bottle made of high density polyethylene and 63.11 grams of K₂CO₃/Rb₂CO₃/Cs₂CO₃ catalyst were charged to the reactor, and the reaction was carried out 0.93 MPa (135 psi) absolute. Immediately after 45.26 cc of water had been metered in (which was approximately 2 hours after the start of the metering of water), the heating was turned off. The reactor was cooled down to room temperature. 39.25 liters of gas was collected in the gas bags and analyzed by Gas Chromatography. A total of 78.12 grams of liquid was collected which include 35.92 grams of aqueous solution and 42.2 grams of organic liquid obtained from all three traps, i.e., the 41.17 apricot to yellow color organic liquid were collected in the room temperature Trap 1 (temperature), 0.58 grams of pale yellow liquid collected in the 0° C. Trap 2, and 0.24 grams of organic liquid in the demisting Trap 3 (w/SiC in it 0° C.). 62.1 grams of charcoal gray solid was recovered from the reactor.

In Experiment 7, the reaction was carried out in the same manner as during Experiment 5 except a feed of 32.91 grams of small pieces (approximately 1″ square pieces) of a reclyclable milk plastic bottle made of high density polyethylene and 63.19 grams of K₂CO₃/Rb₂CO₃/Cs₂CO₃ catalyst were charged to the reactor, and the reaction was carried out 0.48 MPa (70 psi) absolute. Immediately after 34.8 cc of water had been metered in (which was approximately 2 hours after the start of the metering of water), the heating was turned off. The reactor was cooled down to room temperature. 45.5 liters of gas was collected in the gas bags and analyzed by Gas Chromatography. A total of 62.12 grams of liquid was collected which include 33.02 grams of aqueous solution and 29.10 grams of organic liquid obtained from all three traps, i.e., 41.17 apricot and yellow color organic liquid collected in the room temperature Trap 1, and 0.95 grams of organic liquid in the demisting Trap 3 (w/SiC in it 0° C.). 62.5 grams of gray solid was recovered from the reactor.

### Example 8

### Contact of a Waste High Density Polyethylene Milk Container Feed with a Hydrogen Source in the Presence of a Silicon Carbide Catalyst and Steam (Control)

In Experiment 8, the reaction was carried out in the same manner as during Experiment 7 except a feed of 46.02 grams of small pieces (approximately 1″ square pieces) of a reclyclable milk plastic bottle made of high density polyethylene and 60.7 grams of SiC were charged to the reactor, and the reaction was carried out 0.48 MPa (70 psi) absolute. Immediately after 45.69 cc of water had been metered in (which was approximately 2 hours after the start of the metering of water), the heating was turned off. The reactor was cooled down to room temperature. A total of 36.7 liters of gas was collected in the gas bags and analyzed by Gas Chromatography. A total of 78.55 grams of liquid was collected which include approximately 38.56 grams of aqueous solution and approximately 43.65 grams of organic liquid obtained from all three traps, i.e., approximately 40 grams of yellowish brown wax liquid collected in the room temperature Trap 1, 1.86 grams of yellowish brown liquid collected in the 0° C. Trap 2; and 1.79 grams of organic liquid in the demisting Trap 3 (w/SiC in it 0° C.). 61.8 grams of silicon carbide solid was recovered from the reactor.

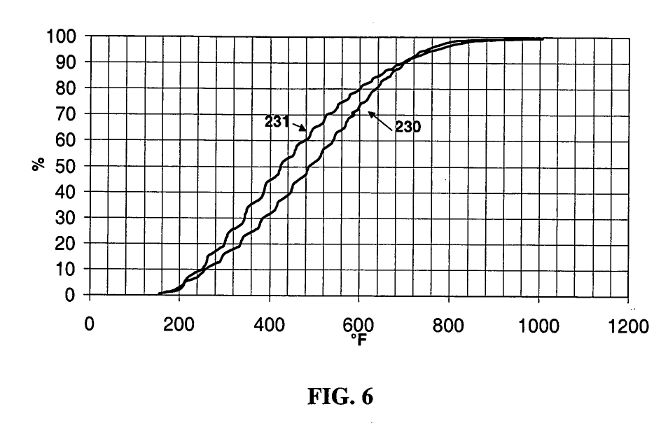

Experiment 5, at atmospheric pressure, a semisolid soft waxy material is obtained. From Experiment 7, at an elevated pressure of 70 psig with the same absolute flow rates of methane and steam, a low viscosity liquid product is obtained. The thermal process, Experiment 8, gives a harder wax at 1 bar, and a liquid at 70 psig, provided the steam and methane reactants are provided to the thermal process. Referring now to FIG. 6, a distillation curve for the products of the resction in the presence of the carbonate salts, line 230, and the products without the carbonate salts present, line 231, are shown. The distillation curve of the polyethylene products shows a similar behavior to that of tires, in that, as shown below, the temperature required to distill a given weight fraction of the product liquid is higher for the catalytic process of the instant invention than the pyrolytic one, indicating molecules of higher carbon number are released. However, the highest boiling constituents are reduced by the catalytic process for polyethylene, as shown by the crossing of the two distillation curves at around 92% weight of products distilled. This means that the highest molecular weight cut produced by the catalytic process is lower than that produced thermally, and that the low molecular weight cuts have a higher molecular weights. Thus, the molecular weight distribution is narrower for the catalytic product, indicating a more selective process.

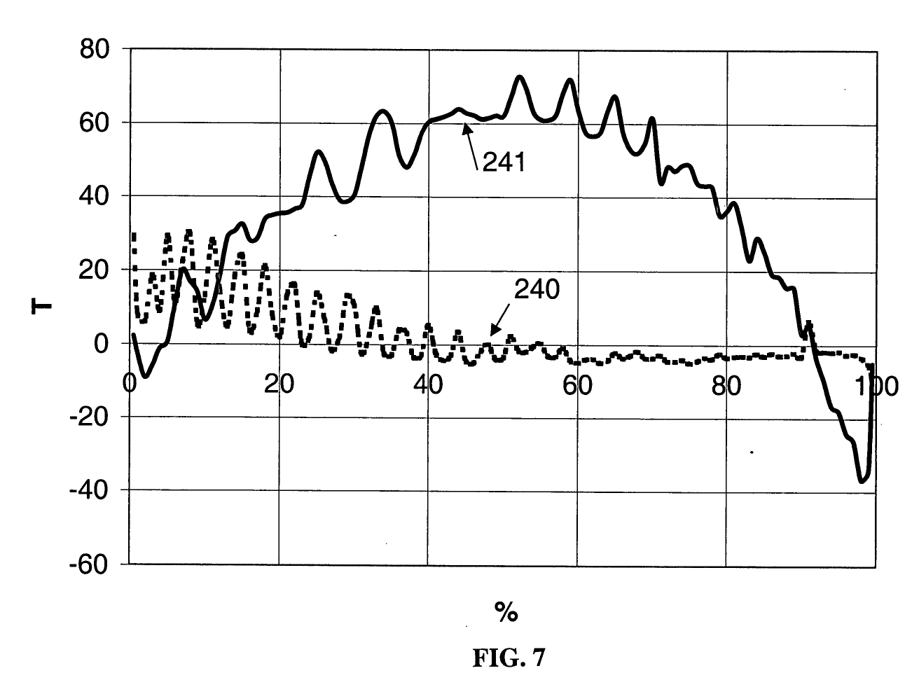

The difference in distillation curves shown in FIG. 7 is shown in FIG. 7 as line 241. As in the tire examples, this plot shows a maximum effect between 50 and 60 weight % of product material distilled. The crossing of the curves at 92% weight distilled to give a boiling point of the catalytic product in the highest boiling fractions of up to roughly 40° F. below that of the pyrolytic product may also be seen. For chemical processes, it may be in certain circumstances, desirable to be able to produce a narrower molecular weight distribution such as is shown in the catalytic case above. It may also be desirable for fuels, for example, in producing diesel fuels with less wax. The magnitude of the molecular weight narrowing effect may be controlled by process conditions. Line 241 of FIG. 7 is the elevation in distillation temperature for the catalytic vs pyrolytic products at 1 bar absolute (0 psig) At one bar pressure, the elevation in distillation temperature only occurs in the first half of the material distilled off; after that, the distillation temperature is reduced, indicating that roughly half of the product (the lower boiling half) is shifted to higher carbon numbers, while the higher boiling half is shifted to lower carbon numbers, again narrowing the molecular weight distribution, but changing the magnitude of the effect.

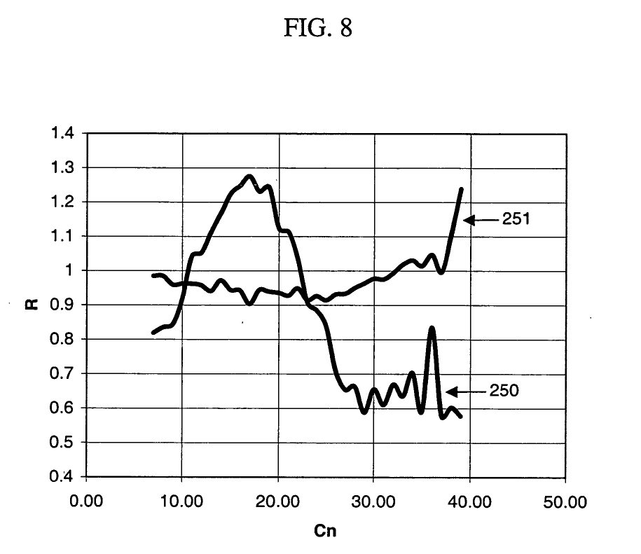

In addition to narrowing the molecular weight distribution of the product, the character of the product is shifted by application of the instant invention, as may be seen by comparing the ratio of alpha olefin to paraffin as a function of carbon number across the boiling range produced. Referring now to FIG. 8, the ratio of the alpha olefin to paraffin as a function of carbon numbers for a product of the reaction in the presence of a carbonate salt and the product of the reaction without the carbonate salt present. Line 250 is this ration from 70 psig runs, and line 251 is the ration for runs at one atmosphere pressure. From FIG. 8 it is clear that when the process is run at 1 bar, a similar ratio of olefin to paraffin is produced by both the catalytic and control processes across the range of carbon numbers (molecular weights) of the products, with an elevation at the highest carbon numbers. At 70 psig however, there is increased alpha olefin to paraffin from C11 to C22, spanning the range of interest for higher olefins for use as detergent intermediates and other valuable uses. Thus for the C13 to C17 cut, the alpha olefin is enhanced by more than 20% by the catalytic process. Alpha olefins in the C13 to C17 range have uses as, for example, feeds for prepration of detergent alcohols. Similarly, at 70 psig, the high molecular weight material is depleted in alpha olefin relative to the control, exactly as is desired for high value paraffin waxes (C25-C40). Over the C25 to C40 range a high paraffin and low olefin content is desired for stability and crystallinity of products. The alpha olefin content is reduced by about 30% with the presence of the carbonate salts, making both the detergent range and wax range products of the catalytic process more desirable than those of the pyrolytic process.

### Examples 9

### Contact of a Waste PET Container Feed with a Hydrogen Source in the Presence of a K₂CO₃/Rb₂C01/Cs₂CO₃ Catalyst and Steam

In Experiment 9, the reaction was carried out in the same manner as during Experiment 5 except a feed of 36.58 grams of small pieces (approximately 1″ square pieces) of clear club soda bottle, water bottle and pretzel bottles—combination made of polyethyleneterephthalate and 63.16 grams of K₂CO₃/Rb₂CO₃/Cs₂CO₃ Catalyst, as described above, were charged to the reactor, and the reaction was carried out 0.93 MPa (135 psi) absolute. Immediately after 45.24 cc of water had been metered in (which was approximately 2 hours after the start of the metering of water), the heating was turned off. The reactor was cooled down to room temperature. A total of 47.3 liters of gas was collected in the gas bags and analyzed by Gas Chromatography. A total of 53.98 grams of liquid was collected which include totally 38.66 grams of aqueous solution and 15.32 grams of bloody red, brown and light brown color organic liquid obtained from all three traps, i.e., 12.94 grams organic liquid collected in the room temperature Trap 1, 1.74 grams of liquid was collected in the 0° C. Trap 2, and 0.64 grams of organic liquid in the demisting Trap 3 (w/SiC in it 0° C.). 66.8 grams of charcoal black solid was recovered from the reactor.

### Example 10

### Contact of a Waste PET Container Feed with a Hydrogen Source in the Presence of a Silicon Carbide Catalyst (Control) and Steam

In Experiment 10, the reaction was carried out in the same manner as during Experiment 5 except a feed of 37.89 grams of small pieces (approximately 1″ square pieces) of a clear soft drink bottle made of polyethyleneterephthalate and 60.28 grams of SiC were charged to the reactor, and the reaction was carried out 0.96 MPa (140 psi) absolute. Immediately after 46.09 cc of water had been metered in (which was approximately 2 hours after the start of the metering of water), the heating was turned off. The reactor was cooled down to room temperature. A total of 34.9 liters of gas was collected in the gas bags and analyzed by Gas Chromatography. 46.9 grams of liquid was collected which include 35.2 grams of aqueous solution and 13.01 grams of organic liquid obtained from all three traps, i.e. 45.6 liquid were collected in the room temperature Trap 1, 0.68 grams of pale yellow liquid collected in the 0° C. Trap 2, and 0.63 grams of organic liquid in the demisting Trap 3 (w/SiC in it 0° C.). 70.1 grams of silicon carbide solid was recovered from the reactor.

### Example 11

### TAP Testing of a K₂CO₃/Rb₂CO₃/Cs₂CO₃ Catalyst and the Individual Inorganic Salts

In all TAP testing, a 300 mg sample was heated in a reactor of a TAP system from room temperature (27° C.) to 500° C. at a rate of 50° C. per minute. Emitted water vapor and carbon dioxide gas were monitored using a mass spectrometer of the TAP system.

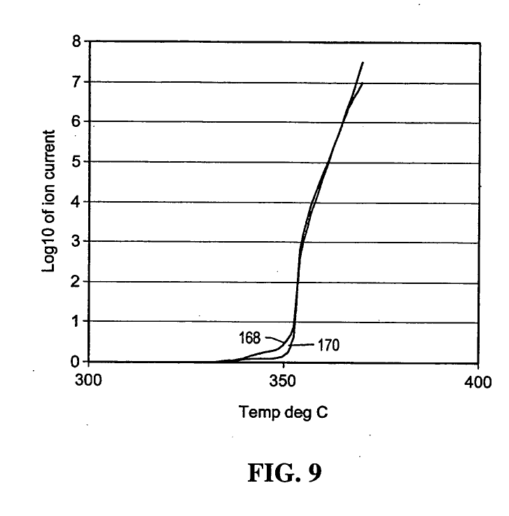

The K₂CO₃/Rb₂CO₃/Cs₂CO₃ catalyst supported on alumina showed a current inflection of greater than 0.2 volts for emitted carbon dioxide and a current inflection of 0.01 volts for emitted water from the inorganic salt catalyst at 360° C. The minimum TAP temperature was 360° C., as determined by plotting the log 10 of the ion current versus temperature. FIG. 9 is a graphical representation of log 10 plots of ion current of emitted gases from the K₂CO₃/Rb₂CO₃/Cs₂CO₃ catalyst (“log (I)”) versus temperature (“T”). Curves 168 and 170 are log 10 values for the ion currents for emitted water and CO₂ from the inorganic salt catalyst. Sharp inflections for emitted water and CO₂ from the inorganic salt catalyst occurs at 360° C.

In contrast to the K₂CO₃/Rb₂CO₃/Cs₂CO₃ catalyst, potassium carbonate and cesium carbonate had non-detectable current inflections at 360° C. for both emitted water and carbon dioxide.

The substantial increase in emitted gas for the K₂CO₃/Rb₂CO₃/Cs₂CO₃ catalyst demonstrates that inorganic salt catalysts composed of two or more different inorganic salts may be more disordered than the individual pure carbonate salts.

### Example 12

### DSC Testing of an Inorganic Salt Catalyst and Individual Inorganic Salts

In all DSC testing, a 10 mg sample was heated to 520° C. at a rate of 10° C. per min, cooled from 520° C. to 0.0° C. at rate of 10° C. per minute, and then heated from 0° C. to 600° C. at a rate of 10.0° C. per min using a differential scanning calorimeter (DSC) Model DSC-7, manufactured by Perkin-Elmer (Norwalk, Conn., U.S.A.).

DSC analysis of a K₂CO₃/Rb₂CO₃/Cs₂CO₃ catalyst during second heating of the sample shows that the salt mixture exhibited a broad heat transition between 219° C. and 260° C. The midpoint of the temperature range was 250° C. The area under heat transition curve was calculated to be −1.75 Joules per gram. The beginning of crystal disorder was determined to start at the minimum DSC temperature of 219° C.

In contrast to these results, no definite heat transitions were observed for cesium carbonate.

DSC analysis of a mixture of Li₂CO₃, Na₂CO₃, and K₂CO₃ during the second heating cycle shows that the Li₂CO₃/Na₂CO₃/K₂CO₃ mixture exhibited a sharp heat transition between 390° C. to 400° C. The midpoint of the temperature range was 385° C. The area under heat transition curve was calculated to be −182 Joules per gram. The beginning of mobility is determined to start at the minimum DSC temperature of 390° C. The sharp heat transition indicates a substantially homogeneous mixture of salts.

### Example 13

### Ionic Conductivity Testing of an Inorganic Salt Catalysts or an Individual Inorganic Salt Relative to K₂CO

All testing was conducted by placing 3.81 cm (1.5 inches) of the inorganic salt catalysts or the individual inorganic salts in a quartz vessel with platinum or copper wires separated from each other, but immersed in the sample in a muffle furnace. The wires were connected to a 9.55 volt dry cell and a 220,000 ohm current limiting resistor. The muffle furnace was heated to 600° C. and the current was measured using a microammeter.

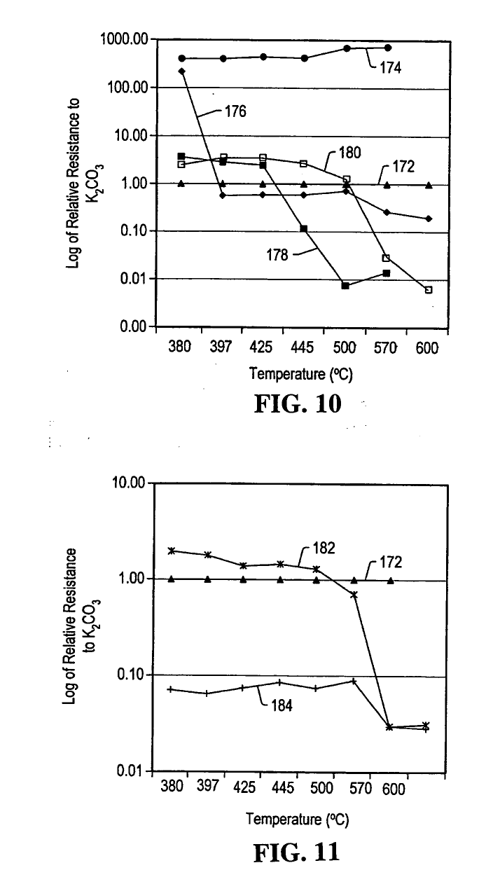

FIG. 10 is a graphical representation of log plots of the sample resistance relative to potassium carbonate resistance (“log(r K₂CO₃)”) versus temperature (“T”). Curves 172, 174, 176, 178, and 180 are log plots of K₂CO₃ resistance, CaO resistance, K₂CO₃/Rb₂CO₃/Cs₂CO₃ catalyst resistance, Li₂CO₃/K₂CO₃/Rb₂CO₃/Cs₂CO₃ catalyst resistance, and Na₂CO₃/K₂CO₃/Rb₂CO₃/Cs₂CO₃ catalyst resistance, respectively.

CaO (curve 174) exhibits relatively large stable resistance relative to K₂CO₃ (curve 172) at temperatures in a range between 380-500° C. A stable resistance indicates an ordered structure and/or ions that tend not to move apart from one another during heating. The K₂CO₃/Rb₂CO₃/Cs₂CO₃ catalyst, Li₂CO₃/K₂CO₃/Rb₂CO₃/Cs₂CO₃ catalyst, and Na₂CO₃/K₂CO₃/Rb₂CO₃/Cs₂CO₃ catalyst (see curves 176, 178, and 180) show a sharp decrease in resistivity relative to K₂CO₃ at temperatures in a range from 350-500° C. A decrease in resistivity generally indicates that current flow was detected during application of voltage to the wires embedded in the inorganic salt catalyst. The data from FIG. 12 demonstrate that the inorganic salt catalysts are generally more mobile than the pure inorganic salts at temperatures in a range from 350-600° C.

FIG. 11 is a graphical representation of log plots of Na₂CO₃/K₂CO₃/Rb₂CO₃/Cs₂CO₃ catalyst resistance relative to K₂CO₃ resistance (“log(r K₂CO₃)”) versus temperature (“T”). Curve 182 is a plot of a ratio of Na₂CO₃/K₂CO₃/Rb₂CO₃/Cs₂CO₃ catalyst resistance relative to K₂CO₃ resistance (curve 172) versus temperature during heating of the Na₂CO₃/K₂CO₃/Rb₂CO₃/Cs₂CO₃ catalyst. After heating, the Na₂CO₃/K₂CO₃/Rb₂CO₃/Cs₂CO₃ catalyst was cooled to room temperature and then heated in the conductivity apparatus. Curve 184 is a log plot of Na₂CO₃/K₂CO₃/Rb₂CO₃/Cs₂CO₃ catalyst resistance relative to K₂CO₃ resistance versus temperature during heating of the inorganic salt catalyst after being cooled from 600° C. to 25° C. The ionic conductivity of the reheated Na₂CO₃/K₂CO₃/Rb₂CO₃/Cs₂CO₃ catalyst increased relative to the ionic conductivity of the original Na₂CO₃/K₂CO₃/Rb₂CO₃/Cs₂CO₃ catalyst.

From the difference in ionic conductivities of the inorganic salt catalyst during the first heating and second heating, it may be inferred that the inorganic salt catalyst forms a different form (a second form) upon cooling that is not the same as the form (a first form) before any heating.

### Example 14

### Flow Property Testing of an Inorganic Salt Catalyst

A 1-2 cm thick layer of powdered K₂CO₃/Rb₂CO₃/Cs₂CO₃ catalyst was placed in a quartz dish. The dish was placed in a furnace and heated to 500° C. for 1 hour. To determine flow properties of the catalyst, the dish was manually tilted in the oven after heating. The K₂CO₃/Rb₂CO₃/Cs₂CO₃ catalyst did not flow. When pressed with a spatula, the catalyst had a consistency of taffy.

In contrast, the individual carbonate salts were free flowing powders under the same conditions.

A Na₂CO₃/K₂CO₃/Rb₂CO₃/Cs₂CO₃ catalyst became liquid and readily flowed (similar, for example, to water) in the dish under the same conditions.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed and certain features of the invention may be utilized independently, all as would be apparent to one skilled in the art after having the benefit of this description of the invention. Changes may be made in the elements described herein without departing from the spirit and scope of the invention as described in the following claims.

1. A process for decomposing a polymeric feed composition comprising:
mixing a polymeric feed composition with an inorganic salt catalyst to produce a total product that includes liquid product mixture which is a liquid at 25° C. and 0.101 MPa, the inorganic salt catalyst exhibits an emitted gas inflection of an emitted gas in a temperature range between 50° C. and 500° C., as determined by Temporal Analysis of Products; and,
controlling contacting condition such that during the contacting at most 0.25 grams of hydrocarbons that are not condensable at 25° C. and 0.101 MPa are formed per gram of polymeric feed, as determined by mass balance.

2. The process of claim 1 wherein, at most, 0.15 grams of hydrocarbons that are not condensable at 25° C. and 0.101 MPa are formed per gram of polymeric feed, as determined by mass balance.

3. The process of claim 2 wherein, at most, 0.07 grams of hydrocarbons that are not condensable at 25° C. and 0.101 MPa are formed per gram of polymeric feed, as determined by mass balance

4. The process of claim 1 further comprising contacting the polymeric feed composition and inorganic salt catalyst with a hydrogen source.

5. The process as claimed in claim 1 wherein the contacting conditions are also controlled such that a contacting temperature is above T₁, wherein T₁ is 30° C. below the TAP temperature of the inorganic salt catalyst, and the TAP temperature is the lowest temperature at which the inorganic salt catalyst exhibit an emitted gas inflection.

6. The process of claim 1 wherein the inorganic salt catalyst having a heat transition in a temperature range between 200° C. and 500° C., as determined by differential scanning calorimetry (DSC), at a rate of 10° C. per minute.

7. The process of claim 1 wherein the heat transition of the inorganic salt catalyst is in a temperature range between 300 and 400° C.

8. The process of claim 7 wherein the heat transition of the inorganic salt catalyst is in a temperature range between 250° C. and 450° C.

9. The process of claim 6 wherein the at least one of the two inorganic salts has a DSC temperature above 500° C.

10. The process of claim 9 wherein the DSC temperature of the inorganic salt catalyst is in a temperature range between 250° C. and 450° C.

11. The process of claim 10 wherein the DSC temperature of the inorganic salt catalyst is in a temperature range between 30° C. and 400° C.

12. The process of claim 1 wherein the inorganic salt catalyst comprises at least two inorganic metal salts, and the inorganic salt catalyst exhibits an emitted gas inflection of an emitted gas in a temperature range, as determined by Temporal Analysis of Products (TAP), and wherein the emitted gas inflection temperature range is between (a) a DSC temperature of at least one of the two inorganic metal salts and (b) a DSC temperature of the inorganic salt catalyst.

13. The process of claim 1 wherein the inorganic salt catalyst comprises at least two inorganic metal salts, and the inorganic salt catalyst has ionic conductivity that is at least, or particularly at least twice, the ionic conductivity of at least one of the inorganic salts of the inorganic salt catalyst at a temperature in a range from 300° C. to 500° C.

14. The process of claim 1 wherein the inorganic salt catalyst comprises one or more alkali metal carbonates, one or more alkaline-earth metal carbonates, one or more alkali metal hydroxides, one or more alkaline-earth metal hydroxides, one or more alkali metal hydrides, one or more alkaline-earth metal hydrides, or mixtures thereof.

15. The process of claim 1 wherein the inorganic salt catalyst comprises one or more alkaline-earth metal carbonates.

16. The process of claim 1 wherein the inorganic salt catalyst comprises one or more alkali metal hydroxides.

17. The process of claim 1 wherein the inorganic salt catalyst comprises one or more alkaline-earth metal hydroxides.

18. The process of claim 1 wherein the inorganic salt catalyst comprises one or more alkali metal hydrides.

19. The process of claim 1 wherein the inorganic salt catalyst comprises one or more alkaline-earth metal hydrides

20. The process of claim 1 wherein the inorganic salt catalyst comprises an alkaline-earth metal salt.

21. The process of claim 20 wherein the inorganic salt catalyst comprises at least two alkaline-earth metal salts.

22. The process of claim 21 wherein an alkali metal has an atomic number of at least 11, and at least one atomic ratio of the alkali metal having an atomic number of at least 11 to an alkali metal having an atomic number greater than 11 is in a range from 0.1 to 10.

23. The process of claim 22 wherein the atomic ratio is in a range from 0.1 to 4.

24. The process of claim 21 wherein the alkali metal salts comprise sodium salts and potassium salts and an atomic ratio of sodium to potassium is in a range from 0.1 to 4.

25. The process of claim 1 wherein the inorganic salt catalyst comprises at least three alkali metal salts.

26. The process of claim 25 wherein at least three of the alkali metals are sodium, potassium, and rubidium, and each of the atomic ratios of sodium to potassium, sodium to rubidium, and potassium to rubidium is in a range from 0.1 to 5.

27. The process of claim 25 wherein at least three of the alkali metals are sodium, potassium, and cesium, and each of the atomic ratios of sodium to potassium, sodium to cesium, and potassium to cesium is in a range from 0.1 to 5.

28. The process of claim 25 wherein at least three of the alkali metals are potassium, cesium, rubidium, and each of the atomic ratios of potassium to cesium, potassium to rubidium, and cesium to rubidium is in a range from 0.1 to 5.

29. The process of claim 1 wherein the hydrogen source comprises hydrogen

30. The process of claim 1 wherein the hydrogen source comprises light hydrocarbons.

31. The process of claim 1 wherein the hydrogen source comprises water.

32. The of claim 1 wherein the process further comprises controlling contacting conditions such that the liquid product mixture has an olefins content of at least 5% greater than the olefins content of the polymeric feed composition, wherein olefins content is as determined by ASTM Method D6730.

33. The process of claim 1 wherein the catalyst comprises one or more alkali metals selected from the group consisting of sodium, potassium, rubidium, cesium, or mixtures thereof and a second alkali metal salt that is selected from the group comprising calcium, magnesium, or mixtures thereof.

34. The process of claim 1 wherein the liquid product has from 0.00001 to 0.03 grams of coke per gram of liquid product.

35. The process of claim 34 wherein the liquid product has from 0.0001 to 0.01 grams of coke per gram of liquid product.

36. The process of claim 1 wherein the polymeric feed comprises tires.

37. The process of claim 1 wherein the polymeric feed comprises high density polyethylene.

38. The process of claim 1 wherein the polymeric feed comprises polyethyleneterephthalate.

39. A process for decomposing a polymeric feed composition comprising:
contacting a polymeric feed composition with an inorganic salt catalyst to produce a total product that includes liquid product mixture which is a liquid at 25° C. and 0.101 MPa, the inorganic salt catalyst wherein the inorganic salt catalyst has a heat transition in a temperature range between 200° C. and 500° C., as determined by differential scanning calorimetry (DSC), at a rate of 10° C. per minute; and,
controlling contacting condition such that during the contacting at most 0.25 grams of hydrocarbons that are not condensable at 25° C. and 0.101 MPa are formed per gram of polymeric feed, as determined by mass balance.

40. The process of claim 39 wherein the DSC temperature of the inorganic salt catalyst is in a temperature range between 250° C. and 450° C.

41. The process of claim 39 wherein the inorganic salt catalyst comprises at least two inorganic metal salts, and the inorganic salt catalyst has ionic conductivity that is at least, or particularly at least twice, the ionic conductivity of at least one of the inorganic salts of the inorganic salt catalyst at a temperature in a range from 300° C. to 500° C.

42. The process of claim 39 wherein the inorganic salt catalyst comprises one or more alkaline-earth metal carbonates.

43. The process of claim 39 further comprising contacting the polymeric feed composition and inorganic salt catalyst with a hydrogen source.

44. The process of claim 39 wherein the polymeric feed is selected from the group comprising polyolefins, polyethylene, polypropylene, epoxy resins, methyl methacrylate, polyurethanes, furan resins, rubber, polymeric wastes, paper, and municipal plastic wastes.

45. The process of claim 39 wherein the polymeric feed comprises tires.

46. The process of claim 39 wherein the polymeric feed comprises high density polyethylene.

47. The process of claim 39 wherein the polymeric feed comprises polyethyleneterephthalate.

48. A hydrocarbon composition comprising:
a ratio of olefinic bonds to aromatic bonds in the range of 0.05 to 0.35;
between about 20% and 50% aromatics by weight;
more than 0.00001% by weight of octadecanenitrile; and
between 0.5 to 5% by weight limonene.

48. The hydrocarbon composition of claim 48 further comprising between 0.05 and 0.5% of each of styrene, ethyl benzene, propyl benzene, and butyl benzene; with a ratio of ethyl benzene to styrene of less than one, a ratio of propyl benzene to butyl benzene of greater than one; a ratio of propyl benzene to ethyl benzene of grater than one.

49. The hydrocarbon compostion of claim 48 having an initial boiling point of 180° F. or greater with a final boiling point less than about 1200° F. with a 50% boiling point in the range of 590° F. to 700° F. and an API gravity between about 15 and 40.

50. A hydrocarbon composition comprising:
at least 45% by weight olefins;
30 to 48% by weight paraffins;
0.5 to 7% by weight aromatics; and
less than 2% by weight polynuclear aromatics, wherein the olefins are at least 60% alpha olefins with a ratio of internal distributed olefins to vinylidene olefins, on a mole basis, of from 2.5 to 4.5.

51. The hydrocarbon composition of claim 50 wherein the alpha olefin to paraffin ration in the range of 1.1 to 1.9 for the C10 molecular fraction, 0.7 to 1.22 for the C8 fraction, 0.7 and 1.27 for the C9 fraction.

52. The hydrocarbon composition of claim 50 wherein there is a peak in the olefin content as a function of carbon number in the carbon number range of 6 to 20

53. A hydrocarbon composition comprising:
between 45% and 85% by weight aromatics;
a ratio of aromatics to alpha plus vinylidene olefins of at least 100:1;
an amount of diphenylketone of between 0.00001% and 4% by weight;
an amount of benzoic acid between 0.1% and 30% by weight;
an amount of toluic acid between 0.05% and 5% by weight; and
with at least 20% of the hydrogen contained in the hydrocarbon composition being aliphatic hydrogen

54. The hydrocarbon composition of claim 53 wherein the composition has an API gravity of 10 to 20; a microcarbon residue of less than 0.3 weight percent; and a sulfur content of less than 0.4%.

55. A liquid product, wherein the liquid product has, per gram of liquid product:
at most 0.05 grams of residue, as determined by ASTM Method D5307;
at least 0.001 grams of hydrocarbons with a boiling range distribution of at most 204° C. (400° F.) at 0.101 MPa;
at least 0.001 grams of hydrocarbons with a boiling range distribution between 204° C. and 300° C. at 0.101 MPa;
at least 0.001 grams of hydrocarbons with a boiling range distribution between 300° C. and 400° C. at 0.101 MPa;
at least 0.001 grams of hydrocarbons with a boiling range distribution between 400° C. and 538° C. (1,000° F.) at 0.101 MPa; and
wherein the hydrocarbons in a boiling range distribution between 20° C. and 204° C. comprise olefins having terminal double bonds and olefins having internal double bonds with a molar ratio of olefins having terminal double bonds to olefins having internal double bonds of at most 0.9 as determined by proton nuclear magnetic resonance;

56. The liquid product as claimed in claim 55, wherein the hydrocarbons in a boiling range distribution between 20° C. and 204° C. have from 0.001 to 0.5 grams of olefins per gram of hydrocarbons in a boiling range distribution between 20° C. and 204° C.

57. A liquid product comprising per gram of liquid product:
at least 0.001 grams of styrene, as determined by flame ionization gas chromatography;
less than 0.005 grams of ethylbenzene, as determined by GC/MS;
at least 0.002 grams of limonene, as determined by GC/MS;
at least 0.000001 grams of octadecanenitrile, as determined by GC/MS
at least 0.001 grams of paraffins, as determined by ASTM Method D6730;
at least 0.001 grams of olefins, as determined by ASTM Method D6730, and
olefins wherein the olefins have at least 0.001 grams of terminal olefins per gram of olefins, as determined by ASTM Method D6730;
at most 0.05 grams of residue, as determined by ASTM Method D5307; and
at least 0.001 grams of a mixture of hydrocarbons that have a boiling range distribution between 20° C. and 538° C. (1,000° F.), as determined by ASTM Method D5307, and the hydrocarbon mixture has, per gram of hydrocarbon mixture:
at least 0.001 grams of naphtha;
at least 0.001 grams of kerosene, and
at least 0.001 grams of vacuum gas oil.

58. The liquid product of claim 57, wherein a weight ratio of atomic hydrogen to atomic carbon (H/C) of the liquid product is at most 1.8.

59. The liquid product of claim 57, wherein the liquid product has an API gravity in a range from 13 to 30 at 15.5° C., wherein API gravity is as determined by ASTM Method D6822.

60. The liquid product of claim 57, wherein the liquid product has from 0.00001-0.03 grams or from 0.0001-0.01 grams of coke per gram of liquid product.

61. A liquid product, wherein the liquid product has, per gram of liquid product:
at most 0.05 grams of residue, as determined by ASTM Method D5307;
at least 0.001 grams of hydrocarbons with a boiling range distribution of at most 204° C. (400° F.) at 0.101 MPa;
at least 0.001 grams of hydrocarbons with a boiling range distribution between 204° C. and 300° C. at 0.101 MPa;
at least 0.001 grams of hydrocarbons with a boiling range distribution between 300° C. and 400° C. at 0.101 MPa;
at least 0.001 grams of hydrocarbons with a boiling range distribution between 400° C. and 538° C. (1,000° F.) at 0.101 MPa;
wherein the hydrocarbons in a boiling range distribution between 20° C. and 204° C. comprise olefins having terminal double bonds and olefins having internal double bonds with a molar ratio of olefins having terminal double bonds to olefins having internal double bonds of at least 3.0, as determined by ASTM Method D6730; and
wherein the hydrocarbons having a boiling range distribution between about 20° C. and about 300° C. comprise compounds with a carbon number of 8 to 15, each of said compounds having at least a ratio of alpha olefins to paraffins of 1.0 to 1.

62. The liquid product as claimed in claim 61, wherein the hydrocarbons in a boiling range distribution between 20° C. and 204° C. have from 0.001 to 0.5 grams of olefins per gram of hydrocarbons in a boiling range distribution between −10° C. and 204° C.

63. A liquid product comprising per gram of liquid product:
at least 0.1 grams of alpha olefins, as determined by FID GC;
at most 0.001 grams of isobutene, as determined by FID GC;
at least 0.001 grams of paraffins, as determined by ASTM Method D6730;
at least 0.001 grams of olefins, as determined by ASTM Method D6730, and the olefins have at least 0.001 grams of terminal olefins per gram of olefins, as determined by ASTM Method D6730;
at most 0.05 grams of residue, as determined by ASTM Method D5307; and
at least 0.001 grams of a mixture of hydrocarbons that have a boiling range distribution between 20° C. and 538° C. (1,000° F.), as determined by ASTM Method D5307, and the hydrocarbon mixture has, per gram of hydrocarbon mixture:
at least 0.001 grams of naphtha;
at least 0.001 grams of kerosene;
at least 0.001 grams of diesel; and
at least 0.001 grams of vacuum gas oil.

64. The hydrocarbon products of claims 63 wherein the carbon number distribution is peaked.

65. The liquid product of claims 63, wherein a weight ratio of atomic hydrogen to atomic carbon (H/C) of the liquid product is at most 1.8.

66. The liquid product of claim 63, wherein the liquid product has an API gravity in a range from 15 to 30 at 15.5° C., wherein API gravity is as determined by ASTM Method D6822.

67. The liquid product of claim 63, wherein the liquid product has from 0.00001 to 0.03 grams of coke per gram of liquid product.

68. A liquid product comprising per gram of liquid product:
at least 0.001 double bonds to olefins having internal double bonds of at least 0.1, grams of paraffins, as determined by ASTM Method D6730;
at least 0.001 grams of olefins, as determined by ASTM Method D6730, and the olefins have at least 0.001 grams of terminal olefins per gram of olefins, as determined by ASTM Method D6730;
at most 0.05 grams of residue, as determined by ASTM Method D5307;
at least 0.001 grams of a mixture of hydrocarbons that have a boiling range distribution between 20° C. and 538° C. (1,000° F.), as determined by ASTM Method D5307, and the hydrocarbon mixture has, per gram of hydrocarbon mixture:
at least 0.001 grams of naphtha;
at least 0.001 grams of kerosene, the kerosene having at least 0.1 grams of aromatics per gram of kerosene, as determined by ASTM Method D5186;
at least 0.001 grams of diesel, the diesel having at least 0.3 grams of aromatics per gram of diesel, as determined by IP Method 368/90; and
at least 0.001 grams of vacuum gas oil (VGO), the VGO having at least 0.1 grams of aromatics per gram of VGO, as determined by IP Method 368/90.

69. A liquid product, wherein the liquid product has, per gram of liquid product:
at most 0.05 grams of residue, as determined by ASTM Method D5307;
at least 0.001 grams of hydrocarbons with a boiling range distribution of at most 204° C. (400° F.) at 0.101 MPa;
at least 0.001 grams of hydrocarbons with a boiling range distribution between 204° C. and 300° C. at 0.101 MPa;
at least 0.001 grams of hydrocarbons with a boiling range distribution between 300° C. and 400° C. at 0.101 MPa;
at least 0.001 grams of hydrocarbons with a boiling range distribution between 400° C. and 538° C. (1,000° F.) at 0.101 MPa; and
wherein the hydrocarbons in a boiling range distribution between 20° C. and 50° C. comprise olefins having terminal double bonds and olefins having internal double bonds with a molar ratio of olefins having terminal particularly at least 0.4 as determined by FID GC.

70. The liquid product of claim 68, wherein the hydrocarbons in a boiling range distribution between 20° C. and 204° C. have from 0.001-0.5 grams of olefins per gram of hydrocarbons in a boiling range distribution between 20° C. and 204° C.

71. A liquid product comprising per gram of liquid product:
at least 0.000001 grams of diphenyl ketone, as determined by GC/MS;
at least 0.001 grams of paraffins, as determined by ASTM Method D6730;
at least 0.001 grams of olefins, as determined by ASTM Method D6730, and the olefins have at least 0.001 grams of terminal olefins per gram of olefins, as determined by ASTM Method D6730;
at most 0.05 grams of residue, as determined by ASTM Method D5307; and
at least 0.001 grams of a mixture of hydrocarbons that have a boiling range distribution between 20° C. and 538° C., as determined by ASTM Method D5307, and the hydrocarbon mixture has, per gram of hydrocarbon mixture:
at least 0.001 grams of naphtha;
at least 0.001 grams of kerosene, the kerosene having at least 0.05 grams of aromatics per gram of kerosene, as determined by ASTM Method D5186;
at least 0.001 grams of diesel, the diesel having at least 0.05 grams of aromatics per gram of diesel, as determined by IP Method 368/90; and
at least 0.001 grams of vacuum gas oil (VGO), the VGO having at least 0.05 grams of aromatics per gram of VGO, as determined by IP Method 368/90.

72. The liquid product of claim 71, wherein a weight ratio of atomic hydrogen to atomic carbon (H/C) of the liquid product is at most 1.8.

73. The liquid product of claim 71, wherein the liquid product has an API gravity in a range from 15 to 30 at 15.5° C., wherein API gravity is as determined by ASTM Method D6822.

74. The liquid product of claim 71, wherein the liquid product has from 0.00001 to 0.03 grams of coke per gram of liquid product.
